(19) United States
(12) Patent Application Publication
(10) Pub. No.: US 2023/0365142 A1
(43) Pub. Date: Nov. 16, 2023

(54) VEHICLE CONTROL DEVICE AND DATA ADJUSTMENT METHOD OF DATABASE

(71) Applicant: Hitachi Astemo, Ltd., Hitachinaka-shi, Ibaraki (JP)

(72) Inventors: Yuuki OKUDA, Hitachinaka-shi, Ibaraki (JP); Takashi OKADA, Hitachinaka-shi, Ibaraki (JP)

(73) Assignee: Hitachi Astemo, Ltd., Hitachinaka-shi, Ibaraki (JP)

(21) Appl. No.: 18/246,543

(22) PCT Filed: Sep. 30, 2021
(86) PCT No.: PCT/JP2021/036230

§ 371 Date: Mar. 24, 2023

(30) Foreign Application Priority Data
Oct. 30, 2020 (JP) 2020-182612

(51) Int. Cl. B60W 50/02; B60W 50/00; B60W 60/00; G07C 5/00; G06F 16/2458

(52) U.S. Cl. CPC B60W 50/0205; B60W 50/0097; B60W 60/001; G07C 5/008; G06F 16/2462; G06F 16/2477; B60W 2520/00; B60W 2540/043; B60W 2556/65

(57) ABSTRACT

An object of the present invention is to provide a vehicle control device that controls an engine so as to improve fuel consumption in consideration of driving characteristics of a driver and an automatic driving system, the vehicle control device being capable of appropriately reflecting the driving characteristics of the driver and the automatic driving system caused by a difference in traffic environment in control, and a data adjustment method of a database. A time-series database 3 that holds a vehicle state including at least acceleration of a host vehicle in time series, a statistical database 4 that divides the vehicle state into a plurality of classes and holds the number of appearances of the vehicle state belonging to any of the divided classes, and a vehicle state prediction unit 2 that predicts a future vehicle state based on information regarding a vehicle state held in the time-series database 3 and the statistical database 4 and a vehicle state newly acquired during traveling of the host vehicle are provided.

### TECHNICAL FIELD

The present invention relates to a vehicle control device that controls an engine so as to improve fuel consumption in consideration of driving characteristics of a driver and an automatic driving system, and particularly relates to a vehicle control device that performs data adjustment of a database necessary for reflecting the driving characteristics of the driver and the automatic driving system in control, and a data adjustment method of the database.

### BACKGROUND ART

For example, PTL 1 discloses a conventional technique related to a vehicle control device.

In the conventional technique described in PTL 1, when an engine is started and caused to travel by engine driving during traveling by motor driving, the engine is prevented from being started when the engine is predicted to be stopped immediately after the engine is started.

According to PTL 1, by providing an engine start suppressing unit that interrupts switching from a motor mode to an engine use mode when deceleration is predicted on the basis of prediction as to whether or not the driver performs a deceleration operation in a case where a vehicle cutting in front of a host vehicle is detected, it is possible to improve fuel consumption deterioration due to repetition of engine start and stop and to obtain better acceleration performance.

As a conventional technique for reflecting driving characteristics of a driver and an automatic driving system in control, for example, there is a technique described in PTL 2.

In the conventional technique described in PTL 2, a steering angle prediction error distribution for a long time is calculated from past steering angle prediction error data, and a current steering angle prediction error distribution is calculated from the latest steering angle prediction error data. From these two distributions, it is determined that the current driving operation is in an unstable state, and an alarm is output.

According to PTL 2, by providing a travel state distribution calculation means for calculating a plurality of travel state distributions based on travel state data detected by a travel state detection means, a distribution difference amount calculation means for calculating a difference amount between the plurality of travel state distributions calculated by the travel state distribution calculation means, and an unstable driving state detection means for determining an unstable driving state from the magnitude of the difference amount calculated by the distribution difference amount calculation means, it is possible to accurately detect an unstable state regardless of a difference in traffic environment.

### CITATION LIST

### Patent Literature

PTL 1: JP 2018-118690 A
PTL 2: JP 2009-9495 A

### SUMMARY OF INVENTION

### Technical Problem

However, in the conventional technique described in PTL 1, an opportunity to improve fuel consumption is limited to the detection of an interruption vehicle, and there is room for improvement in expansion of the opportunity to obtain the effect. In addition, in the conventional technique described in PTL 2, it is considered that whether or not the driver is in an unstable state regardless of a change in traffic environment can be determined, but only a difference in relative characteristics based on a relative comparison of a plurality of travel state distributions does not obtain universal driving characteristics of the driver depending on the traffic environment, and there is room for improvement in reflecting these in control.

In a case where the driver or the automatic driving system on behalf of the driver requests acceleration/deceleration from the vehicle, when an intention, habit, or the like of the driver can be reflected, it is possible to predict the required driving force, braking force, or acceleration related to acceleration/deceleration with higher accuracy.

As a result, in a vehicle using both a motor and an engine, it is possible to appropriately distribute the driving force, and it is possible to improve the accuracy of output restriction of a battery and engine start determination. Alternatively, in a vehicle using an engine as a main power source, it is possible to expand control execution opportunities without sacrificing responsiveness with respect to control involving EGR or supercharging with a relatively large response delay.

That is, an object of the present invention is to provide a vehicle control device that controls an engine so as to improve fuel consumption in consideration of driving characteristics of a driver and an automatic driving system, the vehicle control device being capable of appropriately reflecting the driving characteristics of the driver and the automatic driving system caused by a difference in traffic environment in control, and a data adjustment method of a database.

### Solution to Problem

A vehicle control device according to the present invention includes: a time-series database that holds a vehicle state including at least an acceleration of a host vehicle in time series; a statistical database that divides the vehicle state into a plurality of classes and holds the number of appearances of the vehicle state belonging to any of the divided classes; and a vehicle state prediction unit that predicts a future vehicle state on the basis of information regarding the vehicle state held in the time-series database and the statistical database, and a vehicle state newly acquired while the host vehicle is traveling.

In addition, a data adjustment method of a database according to the present invention is a data adjustment method of at least one database of a time-series database that holds a vehicle state including at least an acceleration of a host vehicle in time series or a statistical database that divides a vehicle state into a plurality of classes and holds the number of appearances of a vehicle state belonging to any one of the divided classes, in which the data of the at least one database is adjusted in order to improve prediction accuracy of a future vehicle state to be predicted on the basis of information regarding the vehicle state held in the time-series database and the statistical database and of a vehicle state newly acquired during traveling of the host vehicle.

### Advantageous Effects of Invention

According to the present invention, in the vehicle control device that controls the engine so as to improve the fuel consumption in consideration of the driving characteristics of the driver and the automatic driving system, the driving characteristics of the driver and the automatic driving system caused by the difference in the traffic environment can be appropriately reflected in the control, and the engine can be controlled so as to improve the fuel consumption in consideration of the driving characteristics of the driver and the automatic driving system regardless of the traffic environment.

Objects, configurations, and effects other than those described above will be clarified by the following description of an embodiment.

### BRIEF DESCRIPTION OF DRAWINGS

FIG. 1 is a schematic configuration diagram of a vehicle on which a vehicle control unit that is a vehicle control device according to a first embodiment is mounted.

FIG. 2 is a block diagram illustrating a main part of the vehicle control unit according to the first embodiment.

FIG. 3 is a block diagram illustrating a vehicle state prediction unit according to the first embodiment.

FIG. 4 is a diagram for explaining an example of a prediction result of a preceding vehicle state according to the first embodiment.

FIG. 5 is a diagram illustrating a calculation flow of a host vehicle state prediction according to the first embodiment.

FIG. 6 is a conceptual diagram illustrating a process of deriving a future acceleration of a host vehicle according to the first embodiment.

FIG. 7 is a diagram for explaining an example of a process of predicting a preceding vehicle state and a host vehicle state according to the first embodiment.

FIG. 8 is an example of a map in which a relationship between an estimated acceleration and a required driving force according to the first embodiment is organized.

FIG. 9 is a table illustrating an example of a time-series database according to the first embodiment.

FIG. 10 is a diagram for explaining a process of holding data in a time-series database according to the first embodiment.

FIG. 11 is a table illustrating an example of a statistical database according to the first embodiment.

FIG. 12 is a diagram for explaining a process of holding data in the statistical database according to the first embodiment.

FIG. 13 is a diagram for explaining data bias caused in the statistical database according to the first embodiment.

FIG. 14 is a diagram illustrating an example of a procedure of correcting the bias of the statistical database according to the first embodiment.

FIG. 15 is a diagram for comparing acceleration estimation errors in the first embodiment and a comparative example.

FIG. 16 is a diagram for comparing acceleration estimation errors in the first embodiment and the comparative example.

FIG. 17 is a block diagram illustrating a main part of a vehicle control unit according to the second embodiment.

FIG. 18 is a schematic configuration diagram of a vehicle illustrating an example in which a database according to a fourth embodiment is provided in a place other than the vehicle.

### DESCRIPTION OF EMBODIMENTS

Hereinafter, embodiments of a vehicle control device according to the present invention will be described with reference to the drawings. In the drawings, the same elements are denoted by the same reference numerals, and redundant description thereof will be omitted.

### First Embodiment

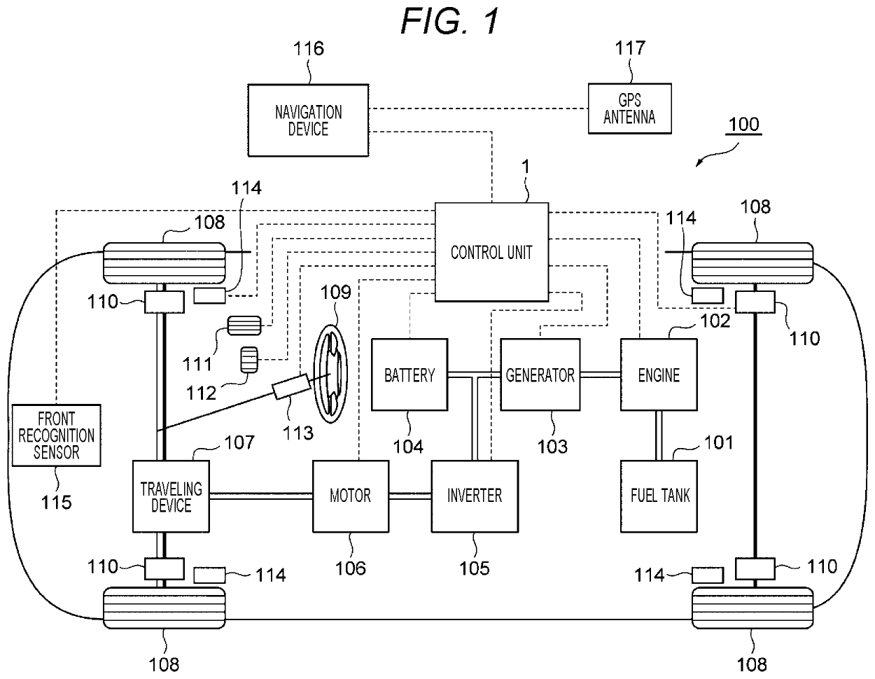

First, a first embodiment of the present invention will be described with reference to FIGS. 1 to 16.

<<Vehicle Configuration>>

FIG. 1 is a schematic configuration diagram of a vehicle 100 equipped with a vehicle control unit 1 (hereinafter, simply referred to as a control unit 1) which is a vehicle control device according to the first embodiment.

The vehicle 100 illustrated in FIG. 1 is a series hybrid electric vehicle in which the vehicle is driven only by a driving force of a motor 106, and converts fuel stored in a fuel tank 101 into kinetic energy (rotational force) via a piston mechanism or a crank mechanism (not illustrated) through conversion from chemical energy to heat and pressure energy by combustion in an engine 102 (internal combustion engine) to drive a generator 103. An input shaft of the generator 103 is rotated by a rotational force of the engine 102, a magnet (not illustrated) is rotated, and electric power is generated by electromagnetic induction. The electric power generated by the generator 103 is charged into the battery 104, and is converted into kinetic energy (rotational force) by the motor 106 via an inverter 105. When the engine 102 is in a stopped state, only electric power of the battery 104 is input to the motor 106 via the inverter 105, and the electric power is converted into kinetic energy. In addition, when the engine 102 is in the stopped state and the motor 106 requires further electric power, the electric power of the battery 104 is used to motor-drive the generator 103 to start the engine 102.

The kinetic energy converted by the motor 106 serves as a driving force for traveling the vehicle 100, and the vehicle 100 is moved forward or backward by rotating wheels 108 via a traveling device 107 to cause the vehicle 100 to travel. By changing angles of the wheels 108 by a steering device 109, the vehicle 100 turns left and right. A brake actuator 110 converts kinetic energy into thermal energy by pressing a friction material against a drum or a disc that rotates together with the wheel 108, and brakes the vehicle 100. Although the above is a simple description, the vehicle 100 can realize motions such as running, turning, and stopping by the above configuration.

The control unit 1 receives an acceleration request from a driver as an operation amount of an accelerator pedal 111, and detects the acceleration request by an accelerator pedal position sensor (not illustrated). The braking request is detected as an operation amount of a brake pedal 112, a brake switch (not illustrated), or a brake fluid pressure (not illustrated). An amount by which the driver operates the steering device 109 is detected by a steering angle sensor 113, and it is detected that there is a turning request to the vehicle 100. A vehicle speed sensor 114 detects a rotation speed of the wheel 108 and detects the rotation speed as a traveling speed of the vehicle 100. In addition, a front recognition sensor 115 detects another vehicle traveling in front of the vehicle 100, a pedestrian, an obstacle on a road, and the like, and measures a moving speed and a distance to an object to detect the moving speed and the distance. Furthermore, a navigation device 116 is provided, which searches for a recommended route to a destination and provides route guidance through display or voice when the driver sets the destination. A global positioning system (GPS) antenna 117 is connected to the navigation device 116. The GPS antenna 117 receives radio waves emitted from a plurality of GPS satellites, and measures a host vehicle position from a propagation time of the radio waves.

The navigation device 116 refers to a map on the basis of host vehicle position information obtained through GPS, and outputs information on a road on which the vehicle 100 travels and an operation state of the navigation device 116 to the control unit 1. Note that the GPS has been described as an example of measuring the host vehicle position, but the present invention is not limited thereto, and the host vehicle position may be specified by other positioning satellite information complementing the GPS information or information provided from a ground facility, and the host vehicle position may be referred to a map.

As the front recognition sensor 115, an imaging device, a radar device, a sonar, or a laser scanner can be suitably used. For example, the imaging device includes a monocular camera or a stereo camera using a solid-state imaging element such as a charge coupled device (CCD) or a complementary metal oxide semiconductor (CMOS), and acquires a road state in front of the host vehicle, a state of an obstacle including a preceding vehicle, regulatory information, an environmental state, and the like by detecting visible light and infrared light. In the case of detecting visible light, a feature regarding a shape of an object is extracted on the basis of a color difference or a luminance difference. In the case of detecting infrared light, radiation is detected by infrared light, and a feature regarding a shape of an object is extracted from a temperature difference.

For example, in the stereo camera, imaging elements capable of extracting features as described above are installed at any intervals and shutter synchronization is performed, and for example, the distance is calculated by obtaining a pixel shift amount as parallax for an image shifted to the left and right. Furthermore, the target direction is calculated on the basis of information such as where the feature exists on the pixel. The information thus acquired is output to the control unit 1.

For example, the radar device detects an obstacle such as another vehicle existing in front of, beside, behind, or the like of the host vehicle, and acquires information such as a distance between the host vehicle and the obstacle, identification information of the other vehicle, and a relative speed v_{d}. The radar device includes an oscillator that oscillates a radio wave and a reception unit that receives the radio wave, and transmits the radio wave oscillated by the oscillator toward an external space. A part of the oscillated radio wave reaches the object and is detected by the reception unit as a reflected wave. By applying appropriate modulation to the amplitude, frequency, or phase of the radio wave to be transmitted, a time difference between transmission and reception detected by the correlation between this and the signal detected by the reception unit is obtained, and the time difference is converted into a distance.

An angle (direction) at which the object exists can be detected by transmitting the radio wave only in a limited direction and changing a transmission direction to scan. The acquired information is output to the control unit 1. In a case where the front recognition sensor 115 is a sonar, the detection can be similarly performed by replacing the radio wave with a sound wave. In addition, in a case where a laser scanner is used, the detection can be similarly performed by replacing a radio wave with a laser beam.

The control unit 1 detects the control states of the engine 102, the generator 103, the battery 104, the inverter 105, and the motor 106, and controls the engine 102, the generator 103, the battery 104, the inverter 105, and the motor 106 so as to realize a request for acceleration, braking, or turning from the driver as described above.

In FIG. 1, there is illustrated a part not connected to the control unit 1, but basically all elements may be connected in some form. Although the present invention is not characterized, in the control unit 1, since processing necessary for operating the vehicle 100 is executed, the presence of connection between the control unit 1 and an element not connected or an element not illustrated is not limited thereto, and there is no problem even when the control unit 1 executes processing other than the processing included in the disclosure of the present invention.

The control unit 1 includes a microcomputer that performs calculation, a central processing unit (CPU), a non-volatile memory (ROM) that stores a program describing calculation processing, a main storage device (RAM) that stores information in the middle of calculation, an A/D converter (Analog-to-Digital-Converter) that quantizes an analog amount of a sensor signal and converts the analog amount into information usable by a program, a communication port for performing communication with other control units 1, and the like, and executes various processes for operating the vehicle 100.

<<Control Unit Configuration>>

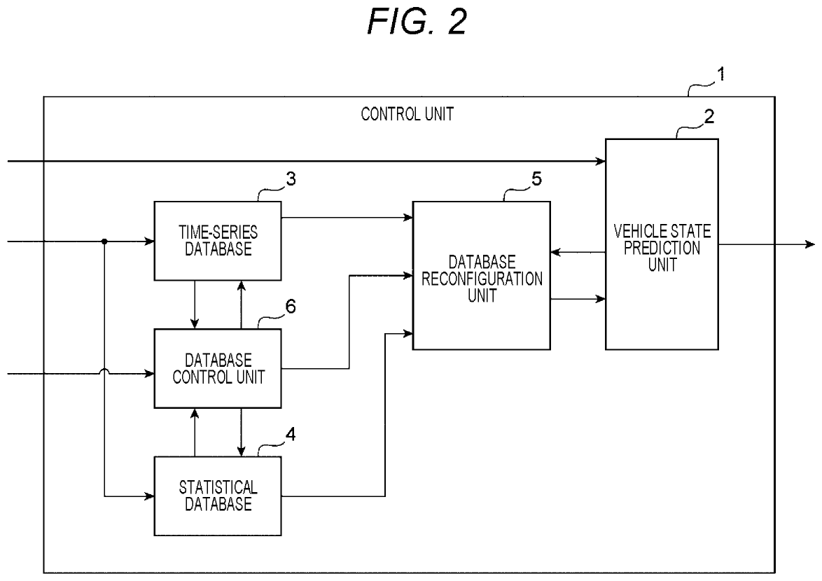

FIG. 2 is a block diagram illustrating a main part of the control unit 1 according to the first embodiment. As illustrated in FIG. 2, the control unit 1 of the present embodiment includes a vehicle state prediction unit 2 that predicts a future vehicle state, a time-series database 3, a statistical database 4, a database control unit 6 that manages and operates these databases, and a database reconfiguration unit 5 that reconfigures the database so that the vehicle state prediction unit 2 uses data held in the database.

<Vehicle State Prediction Unit 2>

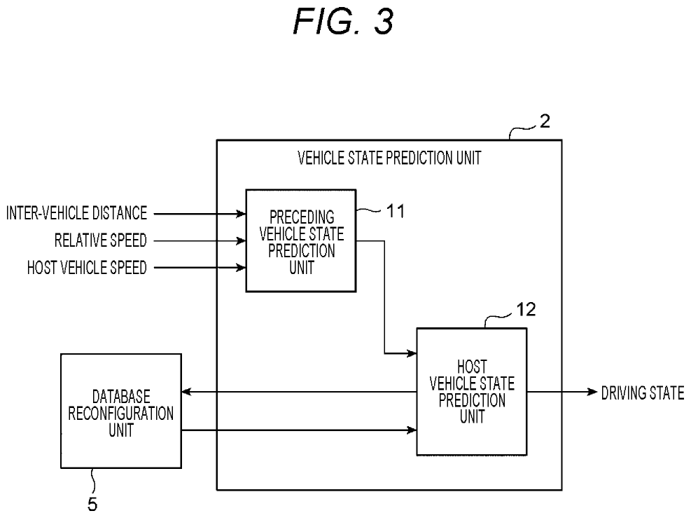

FIG. 3 is a block diagram illustrating a vehicle state prediction unit 2 according to the first embodiment. As illustrated in FIG. 3, the vehicle state prediction unit 2 further includes a preceding vehicle state prediction unit 11 and a host vehicle state prediction unit 12.

<Preceding Vehicle State Prediction Unit 11>

The preceding vehicle state prediction unit 11 predicts a future preceding vehicle state on the basis of an inter-vehicle distance x_{d} between the preceding vehicle and the host vehicle, a relative speed v_{d} between the preceding vehicle and the host vehicle, and a host vehicle speed vₑ. Here, the future preceding vehicle state is information obtained by predicting how a positional relationship (inter-vehicle distance x_{d}) between the preceding vehicle and the host vehicle and the relative speed v_{d} change at a future time such as 5 seconds or 20 seconds. This can be obtained, for example, using the following Equation 1.

$$\begin{matrix}[ Equation 1 ] & \\ {x}_{p} [ k + 1 ] = {x}_{p} [ k ] + {v}_{p} [ k ] {δ}_{τ} + \frac{1}{2} {α}_{p} [ k ] {δ}_{τ}^{2} , τ = k {δ}_{τ} & ( Equation 1 )\end{matrix}$$

In Equation 1, τ represents any selected time on a virtual time axis τₐₓᵢₛ, and k+1 means that one time step elapses from a time step k. In addition, every time one time step elapses, a time step width δ_{τ} of the virtual time elapses. The time step width δ_{τ} is a time step width when considering a lapse of time on a virtual time axis, and is, for example, 0.1 seconds or 1 second. In addition, xₚ is a preceding vehicle position, vₚ is a preceding vehicle speed, and αₚ is a preceding vehicle acceleration. The preceding vehicle speed vₚ[k+1] in a calculation step k+1 next to a certain time step k can be obtained from the preceding vehicle speed vₚ[k] and the preceding vehicle acceleration αₚ[k] as in Equation 2.

[Equation 2]

νₚ[k+1]=νₚ[k]+αₚ[k]δ_{T},τ=kδ_{τ} (Equation 2)

An initial value vₚ[0] of the preceding vehicle speed vₚ in Equations 1 and 2 can be calculated as in Equation 3, for example.

[Equation 3]

νₚ[0]=νₑₛ+ν_{ds} (Equation 3)

In Equation 3, vₑₛ represents a host vehicle speed measured by a speed sensor (for example, the vehicle speed sensor 114), and v_{ds} represents a current relative speed between the preceding vehicle and the host vehicle in real time. The preceding vehicle acceleration αₚ in Equations 1 and 2 is obtained as in Equation 4 using the preceding vehicle speed vₚ[0] obtained by Equation 3 and a preceding vehicle speed v_{pold} obtained by Equation 3 before one processing cycle t_{job} of the control unit 1 in real time.

$$\begin{matrix}[ Equation 4 ] & \\ {α}_{p} = \frac{{v}_{p} [ 0 ] - {v}_{p o l d}}{{t}_{j o b}} & ( Equation 4 )\end{matrix}$$

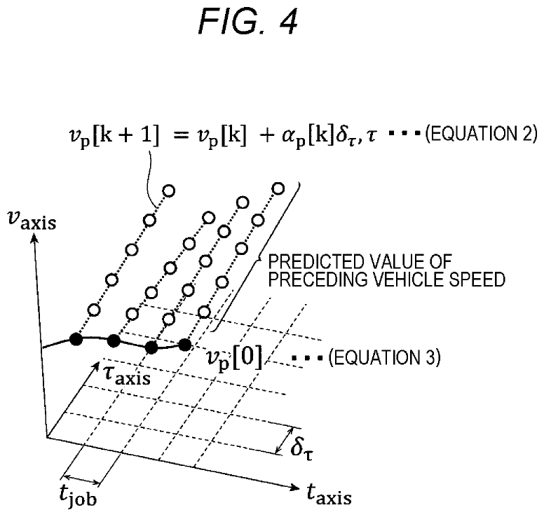

FIG. 4 schematically illustrates this relationship. In FIG. 4, tₐₓᵢₛ represents a real time axis, τₐₓᵢₛ represents a virtual time axis, and vₐₓᵢₛ represents a speed axis. Further, one scale of the real time axis tₐₓᵢₛ is the processing cycle t_{job} of the control unit 1, and one scale of the virtual time axis tₐₓᵢₛ is an arbitrarily settable time step δ_{τ} (for example, 0.1 seconds or 1 second).

When there is a preceding vehicle, the preceding vehicle state prediction unit 11 performs the following calculation for each processing cycle t_{job}. That is, first, the preceding vehicle speed vₚ[0] is calculated using Equation 3 (see black circles in FIG. 4). Next, using the preceding vehicle speed vₚ[0] as an initial value, the preceding vehicle state up to a predetermined time (for example, after 5 seconds) is calculated for each virtual time step δ_{τ} (for example, 0.1 seconds or 1 second) using Equation 2 (see white circles connected by dotted lines in FIG. 4). As a result, the preceding vehicle state can be predicted based on the detection result of the preceding vehicle state for each processing cycle t_{job}.

Meanwhile, in a case where there is no preceding vehicle, an invalid value is output as the preceding vehicle state prediction result, and the host vehicle state prediction in a state where there is no preceding vehicle can be performed.

Since calculation values and measurement values of the preceding vehicle speed vₚ and the preceding vehicle acceleration αₚ include a quantization error and a sensor error, an appropriate filter may be applied. As such a filter, a low-pass filter or a Kalman filter can be suitably used. Note that the initial value vₚ[0] of the preceding vehicle speed and the preceding vehicle acceleration αₚ may be obtained by calculation as described above, may be directly detected using a sensor, or may be a value provided from the preceding vehicle via a communication device or the like.

<Host Vehicle State Prediction Unit 12>

The host vehicle state prediction unit 12 estimates the acceleration \hat{ }αₑ generated in the host vehicle based on the inter-vehicle distance x_{d}, the relative speed v_{d}, the host vehicle speed vₑ, and the preceding vehicle acceleration αₚ, and predicts the required driving force of the driver generated in the host vehicle based on the estimation result of the acceleration.

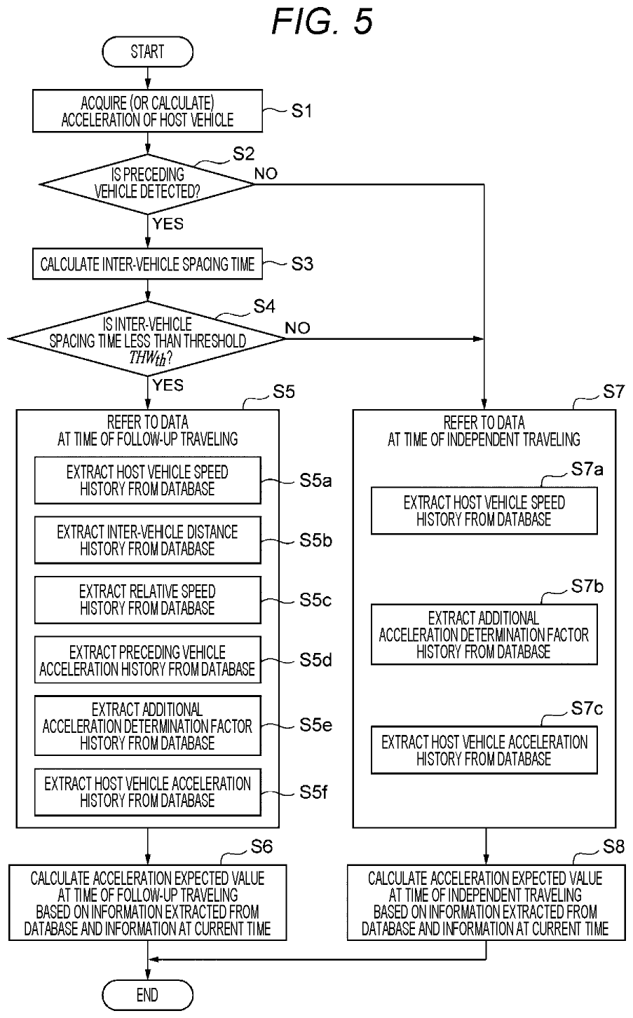

Processing (host vehicle state prediction processing) performed by the host vehicle state prediction unit 12 will be described with reference to a flowchart of FIG. 5.

When the host vehicle state prediction processing starts, first, in Step S1, the host vehicle speed vₑ and a host vehicle acceleration αₑ are acquired. The host vehicle acceleration αₑ may be calculated as illustrated in Equation 5 from the current host vehicle speed vₑₛ measured by the speed sensor and the host vehicle speed v_{eold} measured by the speed sensor at a time before the current time, or an acceleration obtained by an acceleration sensor that directly measures an acceleration generated in the host vehicle may be used. Alternatively, the calculation result or the measurement result may be subjected to an appropriate filter process to extract only a low-frequency component.

$$\begin{matrix}[ Equation 5 ] & \\ {α}_{e} = \frac{{v}_{es} - {v}_{eold}}{{t}_{job}} & \{ Equation 5 )\end{matrix}$$

In Equation 5, v_{eold} is, for example, the host vehicle speed vₑₛ before one processing cycle t_{job}.

In Step S2, it is determined whether a preceding vehicle is detected (that is, whether the output of the preceding vehicle state prediction unit 11 is a valid value). When the preceding vehicle is detected, the process proceeds to Step S3, and if not, the process proceeds to Step S7.

In Step S3, an inter-vehicle spacing time THW is measured based on the current inter-vehicle distance x_{ds} measured by a distance sensor and the host vehicle speed vₑₛ measured by the speed sensor. The inter-vehicle spacing time THW is a time at which the vehicle is expected to reach the preceding vehicle position when the current host vehicle speed yes is continued, and is calculated as in Equation 6.

$$\begin{matrix}\{ Equation 6 ] & \\ THW = \frac{{X}_{ds}}{{v}_{es}} & ( Equation 6 )\end{matrix}$$

In Step S4, the inter-vehicle spacing time THW obtained in Step S3 is compared with a threshold THWₜₕ, and it is estimated whether the host vehicle is traveling following or substantially traveling alone. The process proceeds to Step S5 when the inter-vehicle spacing time THW is less than the threshold THWₜₕ and can be regarded as following travel, and the process proceeds to Step S7 when the inter-vehicle spacing time THW is equal to or more than the threshold THWₜₕ and can be regarded as substantially single travel.

In a case where a general driver follows a preceding vehicle, the general driver often travels with a delay of 2 to 3 seconds from the preceding vehicle, and in this case, the inter-vehicle spacing time THW is relatively small. Meanwhile, when the inter-vehicle distance x_{d} is extremely large even in a case where there is a preceding vehicle, the host vehicle speed vₑ is often determined regardless of the magnitude of the preceding vehicle speed vₚ. Therefore, it is necessary to determine this state as substantial independent traveling. Therefore, it is necessary to set the threshold value THWₜₕ for identifying the follow-up traveling and the substantial independent traveling to a value larger than 2 to 3 seconds and not too large. Therefore, the threshold value THWₜₕ is preferably in a range of 5 seconds to 20 seconds, and is particularly preferably set to, for example, about 10 seconds to 15 seconds.

The threshold THWₜₕ may be changed based on the vehicle speed. For example, it is conceivable to set the threshold value THWₜₕ to about 15 seconds at the time of low speed traveling and reduce the threshold value THWₜₕ to about 5 seconds as the vehicle speed becomes higher. In this way, it is possible to suppress the estimation of the host vehicle behavior assuming the mode of follow-up traveling at the time of substantial independent traveling.

When it is determined in Step S4 that the host vehicle is in the follow-up traveling, the process proceeds to Step S5, and the future acceleration of the host vehicle assuming the follow-up traveling state is estimated. In a case where it is determined in Step S4 that the host vehicle is substantially traveling alone, the processing proceeds to Step S7, and the future acceleration of the host vehicle assuming the independent traveling state is estimated. Hereinafter, in Step S5 or Step S7, information to be referred to for estimating the future acceleration of the host vehicle is defined as an acceleration determination factor.

First, in Step S5a, a host vehicle speed history is extracted from the database. Next, in Step S5b, an inter-vehicle distance history is extracted from the database, and in Step S5c, a relative speed history is extracted from the database. Further, in Step S5d, a preceding vehicle acceleration history is extracted from the database. Moreover, in addition to these, a history of additional acceleration determination factor information that can be an acceleration determination factor for determining the acceleration of the vehicle driven by the driver who drives the host vehicle may be extracted in Step S5e. Examples of such an additional acceleration determination factor include the number of lanes and a speed limit of the road on which the host vehicle is traveling, a positional relationship between the host vehicle and the signal, a color of indication of the signal to be followed by the host vehicle in front, and the like. Since the color of the signal indicated is a category amount such as blue (green), yellow, or red, it is preferable to appropriately convert the color into a numerical value such as 0, 1, or 2. Then, in Step S5f, a host vehicle acceleration history is extracted from the database.

Note that the order of extracting the histories of various amounts from the database is not particularly limited, and the information to be stored in the database is not limited thereto as long as the information is considered to relate to the determination of the acceleration of the driver who drives the host vehicle as illustrated in Step S5e. By increasing the information stored in the database, an amount of information for describing an acceleration expected value increases, and prediction accuracy of the host vehicle acceleration increases. Meanwhile, by reducing the information stored in the database, it is possible to expect an increase in speed of calculation processing and a reduction in memory consumption. Note that the database preferably includes at least a time-series database and a statistical database, which will be described later.

In Step S6, the acceleration (acceleration expected value) requested by the driver who drives the host vehicle is estimated using the information acquired in Step S5.

In the database referred to in Step S5, the acceleration determination factor at a certain time point in the past and the acceleration determined by the acceleration determination factor are held, and in Step S6, the future acceleration is estimated from the relationship between the information at the current time (including the current time point on the virtual time axis), the past acceleration determination factor held in the database, and the acceleration obtained at that time.

Since the database referred to in Step S5 retains the relationship with the acceleration determined when a certain acceleration determination factor is given, a probability distribution of the acceleration that can occur when a similar acceleration determination factor is obtained is estimated by the information of the database referred to in Step S5. The database referred to in Step S5 can be regarded as a state in which a sample obtained from an unknown probability distribution with an unknown probability density is held, and the probability density distribution (of future acceleration) is estimated from this sample. Non-parametric methods such as a histogram method, a parzen window method, a kernel density estimation method, and a nearest neighbor density estimation method can be suitably used for the estimation of the probability density based on such a sample.

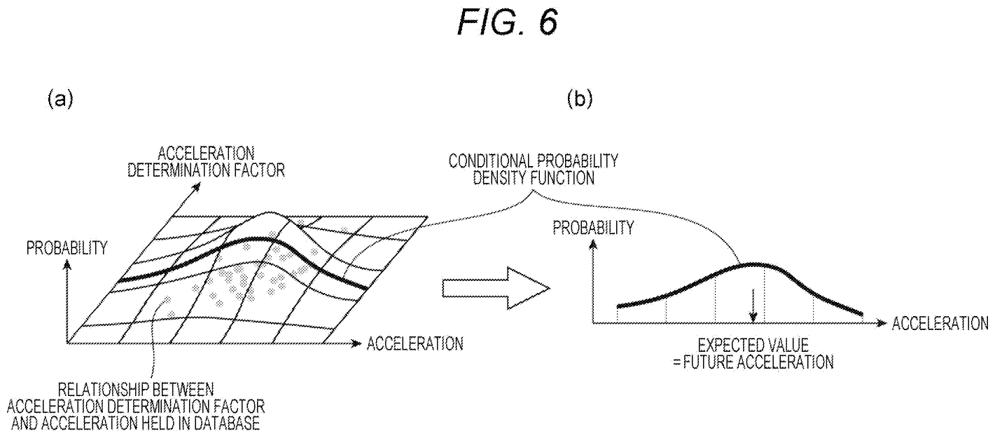

FIG. 6 is a conceptual diagram of a process of deriving a future acceleration expected value using kernel density estimation for the probability density estimation. In order to simplify the description, two-dimensional representation is made, but the present invention is not limited thereto. The information in the database referred to in Step S5 is each of light-colored points in FIG. 6(a), and is developed in a space as a relationship between the acceleration determination factor and the acceleration. By using the kernel density estimation, the probability density can be estimated so as to fill the space between these points, and a simultaneous probability distribution function of the acceleration determination factor and the acceleration is obtained as in the contour line of FIG. 6(a). Here, by obtaining the acceleration determination factor at the present time, it is possible to obtain a conditional probability distribution of acceleration as indicated by a thick line among the contour lines of FIG. 6(a).

As illustrated in FIG. 6(b), the conditional probability distribution of the acceleration is estimated, and a plurality of future acceleration candidates are generated for the distribution function by various sampling methods including an inverse sampling method to approximate the probability density of the future state of the host vehicle, or calculate an expected value for the probability distribution of the future acceleration, so that a highly likely one of the future acceleration candidates is calculated as the estimation result of the host vehicle acceleration.

That is, the host vehicle state prediction unit 12 calculates a highly probable acceleration as an estimated value from an acceleration occurrence history in a similar state on the basis of the host vehicle state obtained for each calculation cycle of the control device or the host vehicle state updated on the virtual time axis on the basis of a combination of the acceleration determination factor accumulated in the database and the acceleration at that time, and estimates the estimated value as the acceleration of the host vehicle.

The host vehicle position and the host vehicle speed on the virtual time axis are calculated based on the estimated acceleration. Similarly to the method indicated by the preceding vehicle state prediction unit 11, the host vehicle state is calculated by updating the state for each time step. The host vehicle position is calculated by Equation 7, and the host vehicle speed is calculated by Equation 8 using the estimation result of the acceleration.

$$\begin{matrix}[ Equation 7 ] & \\ {x}_{e} [ i , k + 1 ] = {x}_{e} [ i , k ] + {v}_{e} [ i , k ] {δ}_{τ} + \frac{1}{2} {\hat{α}}_{e} [ i , k ] {δ}_{τ}^{2} , & ( Equation 7 )\end{matrix}$$

$$τ = k {δ}_{τ}$$

$$\begin{matrix}[ Equation 8 ] & \\ {v}_{e} [ i , k + 1 ] = {v}_{e} [ i , k ] + {\hat{α}}_{e} [ i , k ] {δ}_{τ} , τ = k {δ}_{τ} & ( Equation 8 )\end{matrix}$$

The subscript k in Equation 7 and Equation 8 represents a calculation step, and the subscript i represents each ensemble. xₑ represents the host vehicle position, vₑ represents the host vehicle speed, and \hat{ }αₑ represents the estimated value of a host vehicle acceleration. In addition, δ_{τ} is the time step width on the virtual time axis. By recursively repeating the estimation of the acceleration and the update of the host vehicle state by Equations 7 and 8 described above, it is possible to estimate the acceleration up to a predetermined future time and estimate the driving force requested by the driver on the basis of the obtained acceleration.

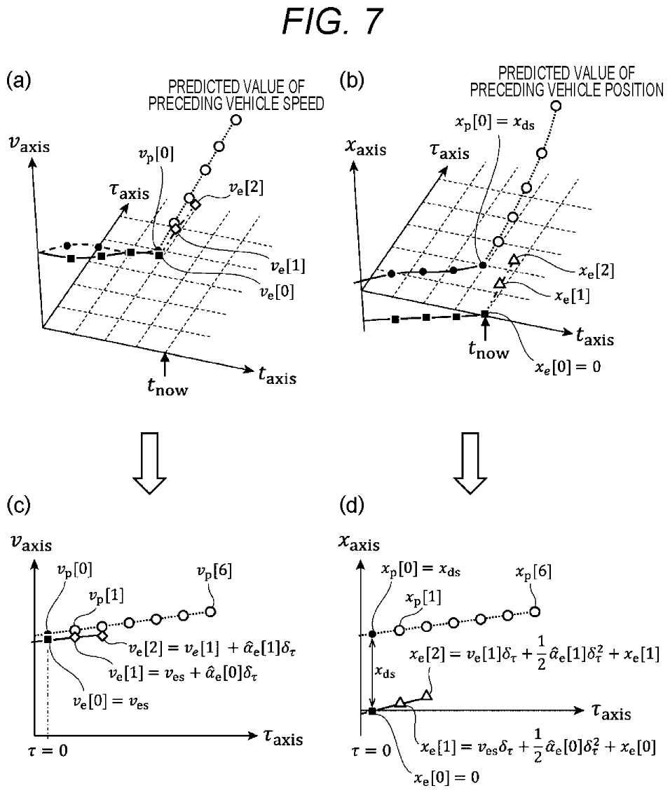

FIG. 7 is a schematic diagram illustrating a process of deriving a preceding vehicle state and a host vehicle state by the vehicle state prediction unit 2.

In FIG. 7(a), tₐₓᵢₛ represents the real time axis, τₐₓᵢₛ represents the virtual time axis, and vₐₓᵢₛ represents the speed axis. As is apparent from the drawing, the preceding vehicle speed vₚ at each time point indicated by a black circle and the host vehicle speed vₑ at each time point indicated by a black square are plotted on the plane of the real time axis tₐₓᵢₛ and the speed axis vₐₓᵢₛ. Further, with the preceding vehicle speed vₚ[0] at a current time t_{now} as an initial value, the future preceding vehicle speed vₚ[k] indicated by a white circle predicted by the preceding vehicle state prediction unit 11 is plotted in the virtual time axis τₐₓᵢₛ direction at time steps δ_{τ} intervals. Further, the host vehicle speed vₑ[0]=vₑₛ at the current time t_{now} is set as an initial value, and the host vehicle speed vₑ[k] indicated by a white square estimated while predicting the acceleration of the host vehicle and the required driving force by the host vehicle state prediction unit 12 is plotted in the virtual time axis τₐₓᵢₛ direction at time steps δ_{τ} intervals. Note that FIG. 7(a) illustrates a state in the middle of the calculation of the host vehicle speed vₑ[k], and thus, only up to vₑ[2] is displayed, but the calculation after vₑ[3] is also performed and plotted.

Similarly, in FIG. 7(b), tₐₓᵢₛ is the real time axis, τₐₓᵢₛ is the virtual time axis, and xₐₓᵢₛ is a position axis. The preceding vehicle position xₚ at each time point indicated by a black circle and the host vehicle position xₑ at each time point indicated by a black square are plotted on the plane of the real time axis tₐₓᵢₛ and the position axis xₐₓᵢₛ. In addition, with the preceding vehicle position xₚ[0] at the current time t_{now} as an initial value, the future preceding vehicle position xₚ[k] indicated by a white circle predicted by the preceding vehicle state prediction unit 11 is plotted in the virtual time axis τₐₓᵢₛ direction at time steps δ_{τ} intervals. Further, the host vehicle position xₑ[0]=0 at the current time t_{now} is set as an initial value, and the host vehicle position xₑ[k] indicated by a white triangle estimated while predicting the acceleration of the host vehicle and the required driving force by the host vehicle state prediction unit 12 is plotted in the virtual time axis τₐₓᵢₛ direction at time steps δ_{τ} intervals. Note that FIG. 7(b) illustrates a state in the middle of calculation of the host vehicle position xₑ[k], and thus, only up to xₑ[2] is displayed, but the host vehicle position xₑ[k] and subsequent positions are calculated and plotted.

Since the vehicle state prediction unit 2 in the control unit 1 of the present embodiment performs the behavior prediction of the host vehicle in the direction of the virtual time axis τₐₓᵢₛ and the prediction processing of the driving force request, the prediction of the direction of the virtual time axis τₐₓᵢₛ at the current time t_{now} will be focused and described below.

FIG. 7(c) is a graph obtained by extracting and two-dimensionally representing the speed prediction result in the direction of the virtual time axis τₐₓᵢₛ at the current time t_{now} in FIG. 7(a) of three-dimensional representation, and FIG. 7(d) is a graph obtained by extracting and two-dimensionally representing the position prediction result in the direction of the virtual time axis τₐₓᵢₛ at the current time t_{now} in FIG. 7(b) of three-dimensional representation.

In FIGS. 7(c) and 7(d), in order to estimate the host vehicle speed vₑ[k] and the host vehicle position xₑ[k] at any selected time when k is k=1 or more, it is necessary to predict the host vehicle acceleration \hat{ }αₑ[k] as a premise as is clear from Equations 1 and 2. As described for the operation of the host vehicle state prediction unit 12, the host vehicle acceleration \hat{ }αₑ[k] calculates, as an estimated value, an acceleration with high probability for the relationship between the past host vehicle state and the acceleration stored in the database. When τ=0, that is, k=1, the acceleration obtained by Equation 5 is adopted as an initial value \hat{ }αₑ[0].

From the acceleration \hat{ }αₑ[k] obtained here, the speed vₑ[k+1] of the next time step is sequentially estimated as in Equation 8. The host vehicle state is changed on the virtual time, and a requested acceleration is estimated by referring to the database based on the host vehicle state obtained by the change.

The driving force required for the vehicle is estimated from the obtained expected value of acceleration \hat{ }αₑ[k]. The driving force may be estimated by converting the acceleration using a motion model in which the motion of the vehicle is replaced with a motion of a mass point system as in Equation 7, or a map in which the required driving force is simply organized with respect to the acceleration and the speed of the vehicle may be prepared.

An example of using the motion model in which the motion of the vehicle is replaced with the motion of the mass point system will be described.

[Equation 9]

F_{d}[k]−Rₐ[k]−Rᵣ[k]−Rₛ[k]−R_{acc}[k]−R_{c}[k]=0 (Equation 9)

In Equation 9, F_{d}[k] is a driving force to be obtained. In addition, Rₐ[k] represents air resistance, Rᵣ[k] represents rolling resistance, Rₛ[k] represents climbing resistance, R_{acc}[k] is acceleration resistance, and R_{c}[k] presents a drag component associated with turning, which are obtained by the following equations.

$$\begin{matrix}[ Equation 10 ] & \\ {R}_{a} [ k ] = \frac{1}{2} ρ {C}_{d} {Av}_{e}^{2} [ k ] & ( Equation 10 )\end{matrix}$$

In Equation 10, ρ represents an air density, and a predetermined value such as 1.1841 kg/m³ may be set on the assumption of 25° C. and 1 atm, or may be corrected on the basis of an environmental temperature or an atmospheric pressure. Cd is a drag coefficient, and a value such as 0.3, 0.25, or 0.35 can be set based on the specifications of the vehicle on which the control unit 1 of the present embodiment is mounted. A is a front projected area of the vehicle, and can be determined based on vehicle specifications, such as 2 m² to 10 m². vₑ[k] is an estimated value of the speed of the vehicle at each time calculated as in Equation 8.

[Equation 11]

Rᵣ[k]=μMg cos(θ[k]) (Equation 11)

[Equation 12]

Rₛ[k]=Mg sin(θ[k]) (Equation 12)

In Equation 11, μ is a rolling resistance coefficient, can be determined according to the state of the wheels mounted on the vehicle 100 or a traveling road surface, and a value such as 0.02 or 0.005 can be set. M is the weight of the vehicle 100, and values corresponding to weight of fuel, the number of occupants, and a loading amount can be set to dry weight of the vehicle. When the number of occupants, the loading amount, and the fuel weight of the vehicle cannot be grasped, a predetermined value obtained by adding a predetermined weight to the dry weight or the dry weight of the vehicle may be set as a representative predetermined value. g is a gravitational acceleration, and a predetermined value such as 9.80665 m/s², 9.8 m/s², or 10 m/s² may be set. θ[k] is a road surface gradient at the position of the vehicle estimated as in Equation 7. The same applies to Equation 12.

[Equation 13]

R_{acc}[k]=(M+ΔM)×(\hat{α}[k]−g sin(θ[k])) (Equation 13)

In Equation 13, ΔM is an inertial weight of the vehicle, and a predetermined value such as 3% or 8% of a vehicle weight M may be set, or a measured value may be used. \hat{ }α[k] is an expected value of acceleration.

$$\begin{matrix}[ Equation 14 ] & \\ {R}_{c} [ k ] = \frac{{M}^{2}}{2 {l}^{2}} ( \frac{{l}_{r}^{2}}{{C}_{f}} + \frac{{l}_{f}^{2}}{{C}_{r}} ) \frac{{v}_{e}^{4} [ k ] {δ}_{s}^{2} [ k ]}{{l}^{2}} & ( Equation 14 )\end{matrix}$$

In Equation 14, 1 is a wheelbase length, l_{f} is the distance from a center of gravity of the vehicle to a center of a front-wheel axle, similarly lᵣ is the distance from the center of gravity of the vehicle to a center of a rear-wheel axle, C_{f} is a cornering stiffness of the front wheel, Cᵣ is a cornering stiffness of the rear wheel, and δₛ is a steering angle of the wheel.

Note that it is not always necessary to accurately derive all the drag components defined by Equations 9 to 14. For example, in a case where the gradient of the route is an unknown value, it may be substituted as a constant value, or considered as movement of a plane, and this may be set to 0. However, in this case, the estimation of the driving force is deteriorated. The drag caused by the turning may also be set to zero by considering the movement of the vehicle as only the forward and backward movements, but the accuracy of estimating the driving force also deteriorates in this case. Needless to say, the accuracy of estimating the driving force is improved as each parameter can be accurately set.

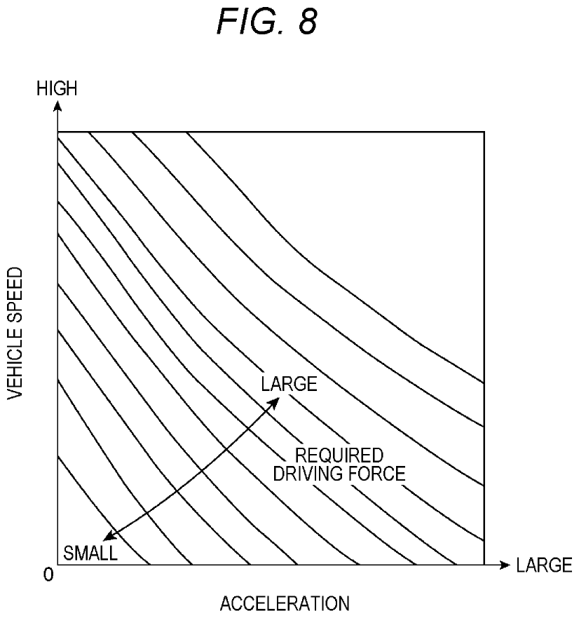

Although the example using the motion model of the mass point system has been described above, a map in which the relationship among the acceleration obtained by the prediction, the vehicle speed, and the required driving force is organized as illustrated in FIG. 8 may be used.

In this way, by obtaining the prospect of the driving force in the future, in the case of a hybrid electric vehicle such as the vehicle 100, by starting the engine in advance in preparation for an expected increase in the driving force in the future, it is possible to perform acceleration without a sense of lackluster. In addition, in a case where the driving force is expected to decrease, it is possible to reduce the fuel consumption by stopping the engine at an early stage and performing only the electric traveling. As a result, the fuel consumption of the vehicle 100 is improved.

Alternatively, when the vehicle 100 performs supercharging by an exhaust turbine, control is performed so as to increase torque responsiveness of the engine by increasing a supercharging pressure in accordance with an increase in the driving force, so that it is possible to eliminate a delay until work of the exhaust turbine becomes available for supercharging, that is, so-called turbo lag.

Furthermore, in an engine that introduces an external EGR, an amount of external EGR can increase or decrease in accordance with the likelihood of the driving force, and by increasing the amount of external EGR cooled in accordance with the increase in the required driving force, it is possible to suppress pre-ignition due to increase in an in-cylinder temperature, and it is possible to take measures such as reducing an introduction amount of the external EGR in accordance with the decrease in the required driving force and avoiding combustion instability at the time of low load.

That is, it is possible to obtain effects such as fuel consumption saving and an increase in torque included in actuators having a relatively low response to a throttle operation such as supercharging or EGR, an ignition timing operation, or an operation of a fuel injection amount without sacrificing the responsiveness.

The method of obtaining the acceleration expected value during the follow-up traveling based on the information extracted from the database in Step S6 and the state of the host vehicle has been described above (FIG. 5).

Note that, in a case where it is determined in Step S2 or Step S4 that the host vehicle is in a state of traveling alone, only the combination of the acceleration determination factors acquired by referring to the database in Step S7 (Steps S7a, S7b, and S7c) is different, and the derivation of the expected value of the acceleration in Step S8 can be calculated in the same manner as the method described in Step S6.

The method of estimating the acceleration performed by the host vehicle state prediction unit 12 of the present embodiment is not limited to the above method, and the relationship between the state of the host vehicle and the acceleration generated by the operation of the driver is held in the database, and a similar effect can be expected as long as it is a method of predicting the acceleration by using this relationship. For example, it is also conceivable to obtain the target variable, that is, the acceleration of the host vehicle by the multinomial approximation using the detection result of the acceleration and the explanatory variable describing the detection result as described above by a linear combination expression obtained by multiplying coefficients by the explanatory variables such as the host vehicle speed vₑ, the relative speed v_{d}, and the inter-vehicle distance x_{d}. Alternatively, the relationship between the host vehicle state and the acceleration may be modeled as a probability model according to the mixed Gaussian distribution, and the database may be referred to as information for generating these distributions.

Alternatively, the inter-vehicle spacing time THW of the driver and the acceleration on the acceleration side and the deceleration side are measured, and when the current inter-vehicle spacing time THW is larger than the obtained average value of the inter-vehicle spacing time, the acceleration is performed by the average acceleration on the acceleration side. Meanwhile, when the current inter-vehicle spacing time THW is smaller than the obtained average value of the inter-vehicle spacing time, the driver requested acceleration may be obtained so as to decelerate by the average acceleration on the deceleration side, and the average value of the acceleration, the average inter-vehicle spacing time, or an average time to collision and the acceleration may be accumulated in the database.

Hereinafter, a database that holds (in other words, reference is made to predict the host vehicle state) information for predicting the host vehicle state such as the acceleration expected value will be described.

<Time-Series Database 3>

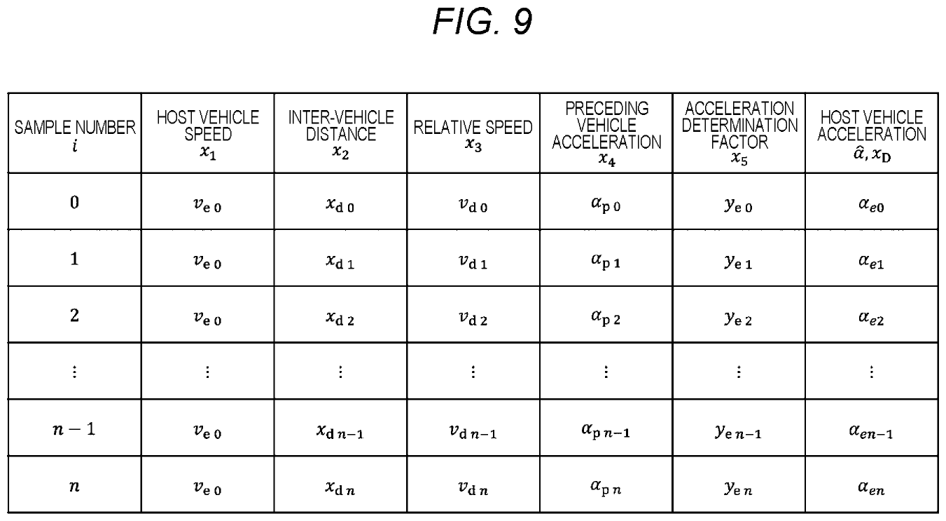

As illustrated in FIG. 9, the time-series database 3 (FIG. 2) is a database that can store acceleration determination factors such as the host vehicle speed vₑ and the inter-vehicle distance x_{d} referred to by the host vehicle state prediction unit 12 for each processing cycle t_{job} of the control unit 1 and can be held as an array or a list structure that can be referred backward for a predetermined time, and it is preferable to set a time of about 1 minute, 5 minutes, or 10 minutes as such a time. In addition, the storage in the time-series database 3 may not be performed for each processing cycle t_{job}, and for example, down-sampling may be performed at predetermined time intervals so as to have a time width larger than the processing cycle t_{job}, such as every 1 second or every 5 seconds. In this case, the number of pieces of data to be stored in the database may be defined such that the number of pieces of sampled data is 500, 1,000, 10,000, or more. There is no problem even when a database that can be referred back to for a substantially longer time (further past) than the time of 1 minute, 5 minutes, or 10 minutes described above is configured by the down-sampling. Sampling may be performed according to the travel distance, such as every 5 m travel or every 10 m travel, or sampling may be performed such that the host vehicle speed vₑ is changed by 1 km/h or 5 km/h, and these may be used in combination.

Depending on the size of the memory mounted on the control unit 1, an upper limit is set for the number of data items that can be held (corresponding to the height of the table in FIG. 9).

After reaching the upper limit number of data to be held, deletion is performed from the oldest data every time new data is held, and the latest data is held in actual time.

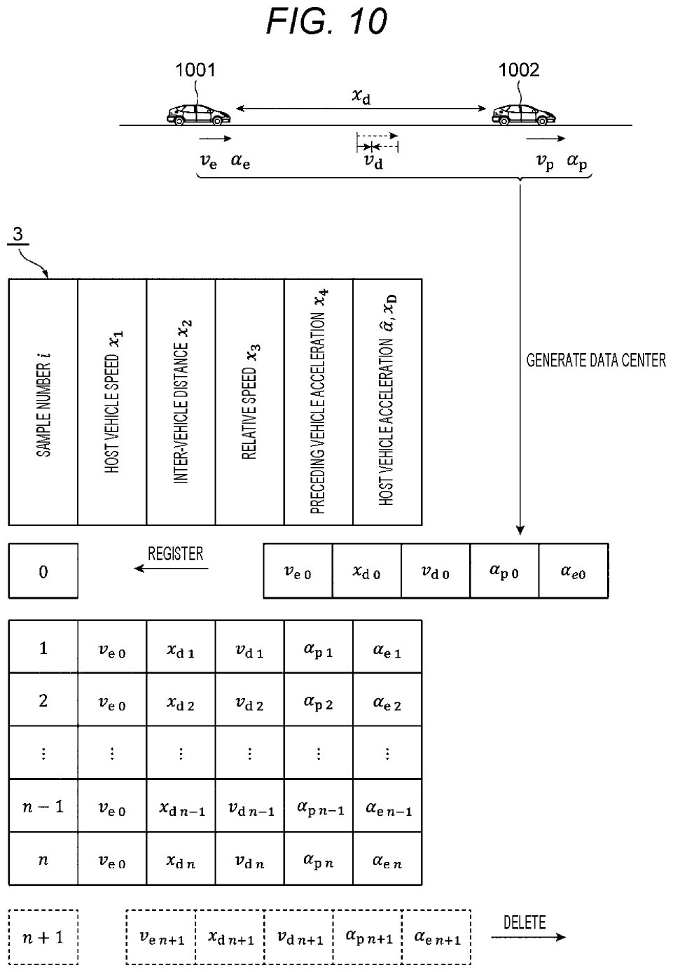

FIG. 10 schematically illustrates a process of storing data in the time-series database 3. A preceding vehicle 1002 is traveling in front of a host vehicle 1001, and an inter-vehicle distance x_{d} between the host vehicle 1001 and the preceding vehicle 1002, a speed vₚ of the preceding vehicle 1002, and an acceleration αₚ are acquired from a sensor (not illustrated) that detects a preceding vehicle state. Further, the speed vₑ and the acceleration αₑ of the host vehicle 1001 are acquired, and the relative speed v_{d} is calculated from the host vehicle speed vₑ and the preceding vehicle speed vₚ. These are stored in time series in the time-series database 3.

n pieces of data, which is the upper limit number of data held, are already held in the time-series database 3, and when data newly measured as a sample number 0 is held in the time-series database 3, n+1th data, which is old data exceeding n pieces, is deleted.

<Statistical Database 4>

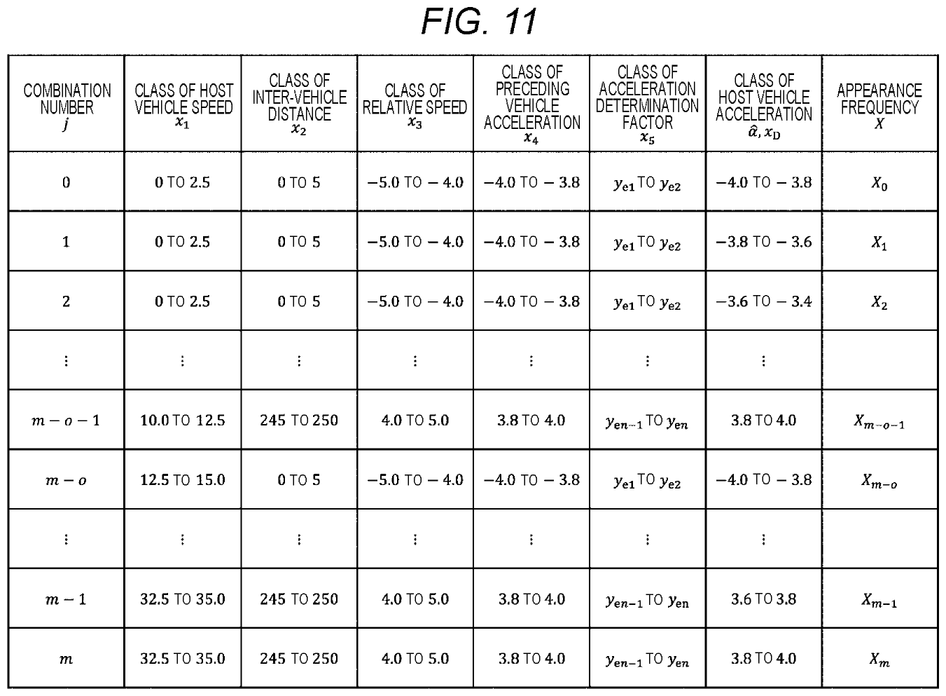

As illustrated in FIG. 11, the statistical database 4 (FIG. 2) stores an acceleration determination factor history such as the host vehicle speed vₑ and the inter-vehicle distance x_{d} referred to by the host vehicle state prediction unit 12 for each processing cycle t_{job} of the control unit 1 similarly to the time-series database 3. However, the statistical database 4 determines whether the host vehicle speed vₑ and the inter-vehicle distance x_{d} acquired for each processing cycle t_{job} belong to any of preset class classifications (specifically, a combination of classes of vehicle state), and enumerates the number of appearances (also referred to as appearance frequencies) of the combinations to hold the travel track record. The time-series database 3 described above stores the acceleration determination factor history at predetermined time intervals or at predetermined travel distances. For storage of data in the statistical database 4, the down-sampling may be performed at predetermined time intervals so as to have a time width larger than the processing cycle t_{job}, or sampling may be performed according to a travel distance such as every 5 m travel or every 10 m travel. Further, it is also possible to perform sampling such that the host vehicle speed vₑ varies by 1 km/h or 5 km/h, and these may be used in combination. In addition, there is no problem even when the predetermined time interval, the travel distance interval, or the speed change timing is different from that of the time-series database 3 described above.

Unlike the time-series database 3 described above, in the statistical database 4, the number of pieces of held data (corresponding to the height of the table of FIG. 11) is determined by the number of combinations for each class and does not change. The statistical database 4 has a feature that a period until data held at a certain time is deleted from the database can be lengthened as compared with the time-series database 3, and thus information in the past or far in time and space can be held as compared with the time-series database 3. Meanwhile, although it is indicated that the acceleration factor belongs to any of the classes of the acceleration determination factors, information such as a specific numerical value is held in a missing state, and thus information having a larger quantization error than that of the time-series database 3 is held.

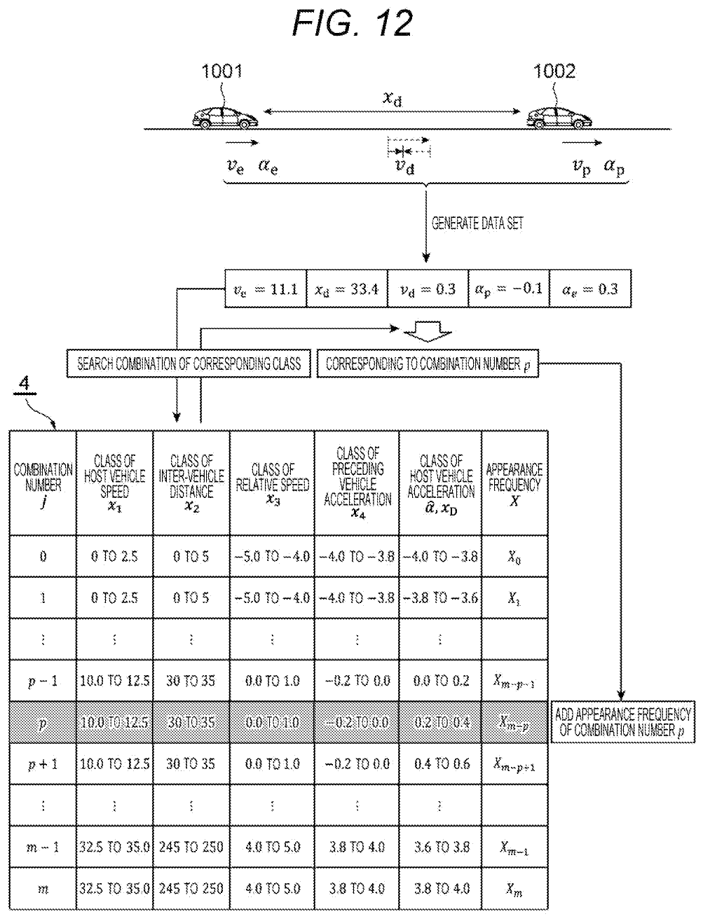

FIG. 12 schematically illustrates a process of storing data in the statistical database 4. Similarly to the process of the time-series database 3 illustrated in FIG. 10, the preceding vehicle 1002 travels in the traveling direction of the host vehicle 1001, and the inter-vehicle distance x_{d} between the host vehicle 1001 and the preceding vehicle 1002, the speed vₚ of the preceding vehicle 1002, and the acceleration αₚ are acquired from a sensor (not illustrated) that detects a preceding vehicle state. Further, the speed vₑ and the acceleration αₑ of the host vehicle 1001 are acquired, and the relative speed v_{d} is calculated from the host vehicle speed vₑ and the preceding vehicle speed vₚ. A data set is configured on the basis of the obtained data, and a combination of classes set in the statistical database 4 is searched. For example, in FIG. 12, assuming that 11.1 m/s is obtained as the host vehicle speed vₑ, similarly, the inter-vehicle distance x_{d} is 33.4 m, the relative speed v_{d} is 0.3 m/s, the preceding vehicle acceleration αₚ is −0.1 m/s², and the host vehicle acceleration αₑ is 0.3 m/s², the search result is returned as a combination of classes including these, which corresponds to the combination number p of the statistical database 4. As a result, it is updated by adding 1 to the number of appearances (appearance frequency) of the combination number p. In this way, the statistical database 4 accumulates the acceleration determination factor history based on the states of the host vehicle and the preceding vehicle.

Note that the range of classes and the width of each class of the statistical database 4 illustrated in FIG. 11 or 12 are not limited thereto, and any form can be taken. For example, there is no problem that the range or class width of the host vehicle speed vₑ or the relative speed v_{d} is changed depending on the performance of the vehicle on which the control unit 1 is mounted or the country or region in which the control unit 1 is operated. Similarly, the preceding vehicle acceleration αₚ or the host vehicle acceleration αₑ may be acceleration that can occur or a range or class width that can be taken in the normal use range of the vehicle. For example, in a case where acceleration such as 1 G (=9.8 m/s²) can be realized as the maximum acceleration or the maximum braking force of the vehicle, the range of combination may be set so as to include the acceleration, or the range may be set so as not to include the acceleration. By providing a database that can hold a combination of conditions that are considered to be rare as a case, the estimation accuracy of the host vehicle acceleration can be enhanced in various scenes, and the memory usage for holding these increases. In addition, in the class width, there is no problem even when a value such as 1 time or 2 times the bandwidth in the kernel density estimation described as an example of the acceleration estimation illustrated in the host vehicle state prediction unit 12 is adopted, or a value is set so as to divide a range taking the class of the acceleration determination factor into classes such as 10 division and 100 division. As the class is set more finely, the quantization error can be reduced and the acceleration determination factor history can be accumulated, while the memory usage increases.

The time-series database 3 and the statistical database 4 have been described above.

The control unit 1 of the present invention is characterized in that the control unit 1 includes databases having different characters such as the time-series database 3 and the statistical database 4.

<Database Reconfiguration Unit 5>

The database reconfiguration unit 5 (FIG. 2) converts data in different modes held in the time-series database 3 and the statistical database 4 described above into a mode in which the vehicle state prediction unit 2 can easily operate the data. The data held in the time-series database 3 can be used as it is for the calculation of the equation illustrated as an example of acceleration estimation, whereas the data held in the statistical database 4 cannot be used as it is for the calculation of the equation. Therefore, the data held in the statistical database 4 is transformed into a form that can be used for the calculation of the equation.

For example, the data can be reconstructed to be represented by a median of the classes of each acceleration determination factor. In this case, the data having the median value of the class of each acceleration determination factor is restored in a form of being temporarily added to the time-series database 3 by the number of appearances of a specific combination. Alternatively, any value in the class width of each acceleration determination factor may be randomly selected to restore the data.

As described above, the database reconfiguration unit 5 reconfigures the database used for the estimation of the acceleration by the host vehicle state prediction unit 12 in the vehicle state prediction unit 2 using the data held in the time-series database 3 and the statistical database 4.

<Database Control Unit 6>

The database control unit 6 (FIG. 2) is characterized by performing, on the time-series database 3 and the statistical database 4, an operation of deleting data from the time-series database 3 and an adjustment of data to the statistical database 4 on the basis of position information (traveling position) of the host vehicle, the duration of traveling, or bias of data held in the statistical database 4 so that the estimation accuracy of the acceleration in the host vehicle state prediction unit 12 of the vehicle state prediction unit 2 can be further improved. Here, the adjustment of data means that a part or all of data is deleted with respect to the time-series database 3, the bias is eliminated by reducing the number of appearances of a combination in which the number of appearances of combinations in the statistical database 4 is extremely large, and further, the number of appearances of combinations is reduced to reduce the total.

(Data Adjustment Processing of Time-Series Database 3)

When it is determined that the data held in the time-series database 3 is unsuitable for the current travel environment based on the position information (travel position) of the host vehicle, the database control unit 6 commands the host vehicle to delete the data and reconstruct the database.

For example, position information is acquired through GPS or the like, and a type of a road on which the vehicle travels is determined with reference to a map. Alternatively, a change in the road type may be detected on the basis of information provision from a road infrastructure through passage through an entrance gate or a toll gate, an optical beacon, or the like.

The type of the road referred to herein is intended to be different from a road provided on a national expressway, an automobile exclusive road, a general road, a private land, or the like, and when it is considered that a traveling characteristic required of the vehicle by the driver changes between a case of traveling on the expressway and a case of traveling on the general road, it is difficult to consider that prediction based on an acceleration determination factor history accumulated by traveling on the general road is appropriate when the vehicle moves from the general road to the national expressway.

Therefore, instead of waiting for the acceleration determination factor accumulated in the time-series database 3 to be replaced with the acceleration determination factor obtained by traveling on the national expressway after a lapse of a certain period of time, the database control unit 6 deletes (delete part of information or all information about previous driving environment) the information held in the time-series database 3 by determining that the traveling environment has changed on the basis of the position information, and can suppress prediction of inappropriate acceleration by the acceleration determination factor accumulated in the previous traveling environment (traveling on a general road), and can enhance the acceleration estimation accuracy in the host vehicle state prediction unit 12.

When the acceleration determination factor accumulated in the time-series database 3 is deleted in this way, the data may be restored to the time-series database 3 by the same method as the operation of restoring the data held in the statistical database 4 to the time-series database 3 in the database reconfiguration unit 5. In this case, it is preferable that only data belonging to at least the same class as the speed acquired at the present time regarding the speed of the host vehicle is selectively restored from the statistical database 4 so that data in a form similar to the traveling state of the host vehicle is held in the time-series database 3.

(Data Adjustment Processing of Statistical Database 4)

In addition, the database control unit 6 performs adjustment to correct the bias of the data held in the statistical database 4 on the basis of the bias of the data held in the statistical database 4.

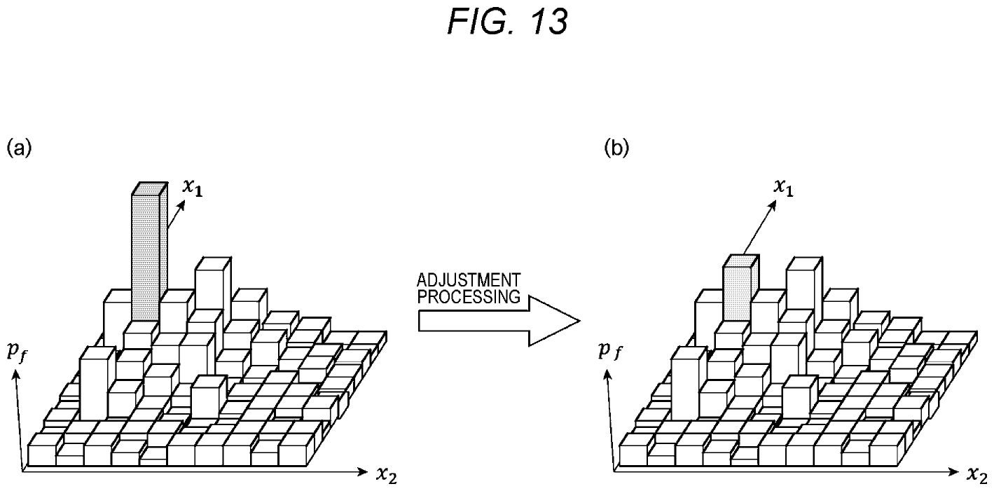

FIG. 13 schematically illustrates a state in which data held in the statistical database 4 is biased. As also illustrated in FIG. 11, although the acceleration determination factor held in the statistical database 4 is configured by multidimensional state variables, a two-dimensional database configuration is taken as an example for simplification of description and visualization.

A height of a rectangular parallelepiped illustrated in FIG. 13 indicates the number of appearances of the combination. At this time, many combinations of the rectangular parallelepipeds painted in dark colors in FIG. 13(a) are held, and the database is in a state of being biased. The database control unit 6 corrects the bias of the data of the statistical database 4, and adjusts the bias so as to obtain the distribution of the number of appearances as illustrated in FIG. 13(b), for example.

Some examples of a method of adjusting the bias of the data held in the statistical database 4 in the database control unit 6 will be described.

In the first method, the bias is adjusted such that the information entropy of the statistical database 4 is maximized (in other words, increase) by reducing the number of appearances of the combinations causing the bias in the statistical database 4.

The database control unit 6 calculates the total number of appearances of the combinations held in the statistical database 4. Next, a ratio of the number of appearances of each combination to the total number of appearances of the combinations is calculated. Here, for a combination in which the ratio of the number of appearances exceeds a predetermined ratio, the number of appearances of the combination is reduced so that the information entropy of the statistical database 4 is maximized (in other words, increase), whereby the bias is adjusted. As such a predetermined ratio, for example, a value such as 1% or 3% can be set, and it is preferable to make the ratio smaller as the number of combinations is larger on the basis of the number of combinations held by the statistical database 4. For the number of combinations exceeding 5000, a value obtained by multiplying the reciprocal of the number of combinations by 100 or 50 may be used. Alternatively, the information entropy of the statistical database 4 may be calculated, and it may be triggered that the information entropy falls below a predetermined value.

The information entropy can be obtained by Equation 15.

$$\begin{matrix}[ Equation 15 ] & \\ E = - {\sum }_{xi ∈ X} {P}_{( {x}_{í} )} log ( {P}_{( {x}_{i} )} ) & ( Equation 15 )\end{matrix}$$

In Equation 15, X is a set of the number of appearances held in the statistical database 4, and xᵢ is an appearance probability in each combination number, that is, the ratio of the number of appearances to the total number of appearances.

For example, the maximum value (maximum entropy) of the information entropy can be calculated on the basis of the number of combinations included in the statistical database 4, and can be calculated from Equation 16.

[Equation 16]

Eₘ=log(n) (Equation 16)

In Equation 16, n is the number of class combinations in the statistical database 4.

The bias may be corrected assuming that the bias occurs in the statistical database 4 when the information entropy of the statistical database 4 decreases to about 0.7 times or 0.75 times the maximum entropy thus obtained. Note that, in such adjustment of the bias, it is preferable to determine the necessity of correction of the bias on one condition that the total number of appearances of the combinations held in the statistical database 4 exceeds a predetermined amount. This is because the information entropy easily decreases when the number of appearances of the combination is not held in the statistical database 4 to some extent. As the total value of the number of appearances, a value such as 10,000 or 5 times or 10 times the number of combinations can be set.

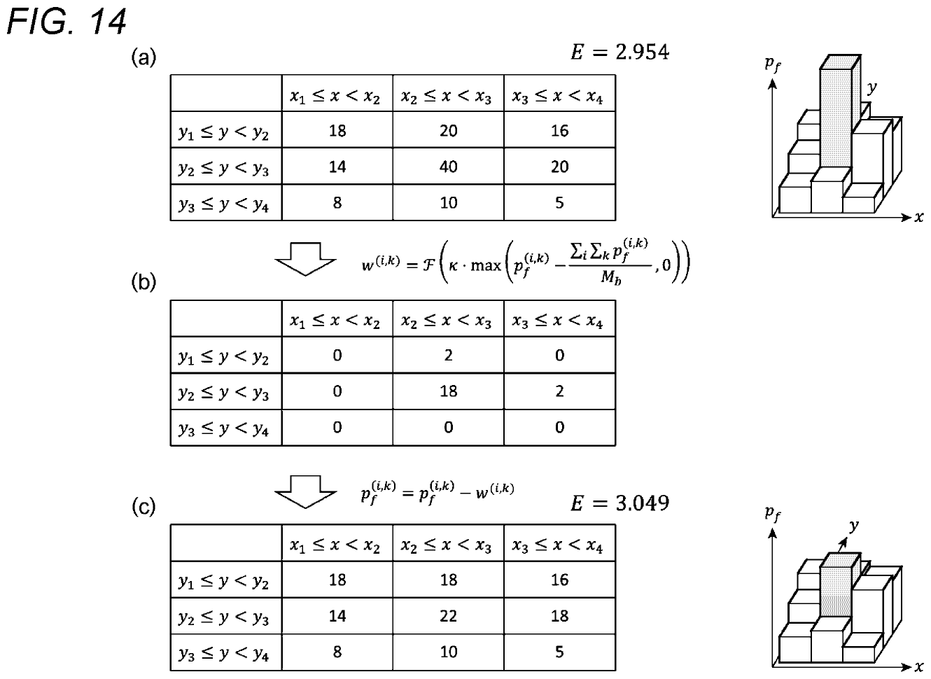

In the second method, the number of appearances of the combination held in the statistical database 4 is reduced by the number obtained by multiplying the excess over the average by a value less than 1 with respect to the number of appearances of the combination exceeding the average. As compared with the first method, it is possible to correct the bias of the statistical database 4 at a higher speed. FIG. 14 is a diagram illustrating an outline of bias adjustment of the statistical database 4 by this method. FIG. 14 illustrates an example of a very simple statistical database 4 developed in two dimensions in order to simplify the description.

In FIG. 14, there are three classes for each of the variable x and the variable y representing the vehicle state, and the number of combinations is 9. In addition, the numbers 18 and 20 in the table of FIG. 14(a) are the number of appearances of combinations such as x₁≤x<x₂ and y₁≤y<y₂ and x₂≤x<x₃ and y₁≤y<y₂. In addition, a numerical value such as E=2.954 illustrated in the upper right of the table is information entropy (E).

In FIG. 14(a), it is assumed that the number of appearances of the combination of the classes of x₂≤x<x₃ and y₂≤y<y₃ is 40, and for example, it is determined that the bias occurs in the statistical database 4 in this state. Here, as a correction amount for reducing the number of appearances of the combination by the number obtained by multiplying the excess over the average by a value less than 1 for the number of appearances exceeding the average with respect to the number of appearances of the held combination, a correction amount is determined by Equation 17 as in FIG. 14(b). By reducing the original number of appearances by the correction amount calculated by Equation 17 as in Equation 18, the number of appearances of the combination of the classes of x₂≤x<x₃ and y₂≤y<y₃ is reduced to 22 as in FIG. 14(c), and it can be seen that the bias of the statistical database 4 is eliminated and the information entropy (E) increases.

$$\begin{matrix}[ Equation 17 ] & \\ {w}^{( i , k )} = ℱ ( κ \cdot max ( {p}_{f}^{( i , k )} - \frac{{\sum }_{i} {\sum }_{k} {p}_{f}^{( i , k )}}{{M}_{b}} , 0 ) ) & ( Equation 17 )\end{matrix}$$

$$\begin{matrix}[ Equation 18 ] & \\ {p}_{f}^{( i , k )} = {p}_{f}^{( i , k )} - {w}^{( i , k )} & ( Equation 18 )\end{matrix}$$

In Equation 17, F is a rounding function, and the calculation result is rounded to an integer in the negative infinite direction. κ is a calculation coefficient of the correction amount with respect to an error from the average value of the number of appearances, and a value less than 1 is used. For example, the value is 0.4, 0.5, or 0.8. Pf is the number of appearances of class combinations, and M_{b} is the number of combinations (here, 9). The superscript of Pf in Equations 17 and 18 means the i-th and k-th combinations of the classes of x and y in the two-dimensional combination of classes in FIG. 14.

Although some examples have been described as a method of correcting the bias of the statistical database 4, the present invention is not limited thereto, and it is sufficient that the number of appearances of the combination can be adjusted such that at least the information entropy of the statistical database 4 increases when the bias occurs in the number of appearances of the combination in the statistical database 4. Although the method of increasing the information entropy by reducing the number of appearances has been mainly described, the information entropy may be increased by adding the number of appearances. However, in the database reconfiguration unit 5, when the data is temporarily restored to the time-series database 3 on the basis of the data of the statistical database 4, the number of pieces of data increases, so that a calculation load increases. Therefore, from the viewpoint of calculation load, it is preferable to increase the information entropy by reducing the number of appearances of combinations held in the statistical database 4.

In addition, even when there is no bias in the statistical database 4, in a case where the total number of appearances of the combinations exceeds 50 times or 100 times the number of combinations or exceeds a predetermined number such as 10,000 times or 100,000 times, the database control unit 6 may adjust the data held in the statistical database 4 such that the total number of appearances of the combinations in the statistical database 4 decreases by a method of multiplying the number of appearances of all the combinations in the statistical database 4 by a number less than 1, for example, 0.5, or the like and rounding it to an integer in the negative infinite direction. In this way, when the data in the statistical database 4 is temporarily held in the time-series database 3, the database reconfiguration unit 5 can suppress an excessive increase in the number of data and reduce the calculation load.

Furthermore, the database control unit 6 may adjust the data held in the statistical database 4 such that the total number of appearances of the combinations in the statistical database 4 decreases by a method of multiplying the number of appearances of all the combinations in the statistical database 4 by a number less than 1, for example, 0.5, every time the vehicle travels 1000 km or every time the accumulation of the traveling time elapses 10 hours, and rounding it to an integer in the negative infinite direction. Similarly, when the data in the statistical database 4 is temporarily held in the time-series database 3, it is not necessary to suppress an excessive increase in the number of pieces of data or to increase the data length for holding the number of appearances, and memory efficiency of the control unit 1 is improved.

As described above, the database control unit 6 is characterized by performing, on the time-series database 3 and the statistical database 4, an operation of deleting data from the time-series database 3 and an adjustment of a bias of data from the statistical database 4 on the basis of the position information (traveling position) of the host vehicle, the duration of traveling, or the bias of data held in the statistical database 4.

(Data Adjustment Effect of Time-Series Database 3)

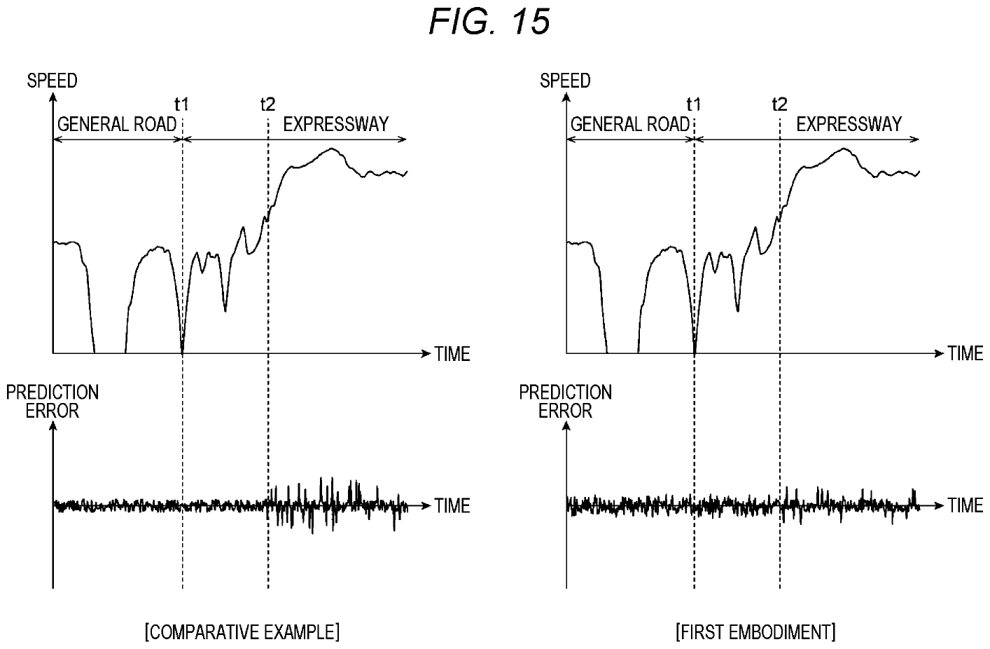

FIG. 15 illustrates a comparison between the acceleration estimation errors in a case (first embodiment) where the adjustment of the time-series database 3 is performed in the first embodiment of the present invention and a case (comparative example) where the adjustment of the time-series database 3 is not performed. The upper chart of FIG. 15 illustrates a speed change of the host vehicle, and the lower chart illustrates an actual measurement value of acceleration and the errors in the acceleration estimation according to the comparative example and the first embodiment.

In the example illustrated in FIG. 15, a travel environment changes from a general road to an expressway at the timing of time t1.

Here, in the comparative example in which the deletion processing of the time-series database 3 is not performed, there is a case where estimation in which the error of the acceleration becomes large is performed from the vicinity indicated by a time t2, and a wrong estimated value is calculated because the previous travel track record remains in the time-series database 3 even though the travel environment has changed. Meanwhile, in the first embodiment in which the time-series database 3 is updated, it is indicated that the acceleration estimation error after the time t2 is suppressed to be small as compared with the comparative example, that is, it is indicated that the present embodiment can accurately realize the estimation of the future acceleration of the host vehicle and can accurately obtain the prospect of the future driving force of the host vehicle.

(Data Adjustment Effect of Statistical Database 4)

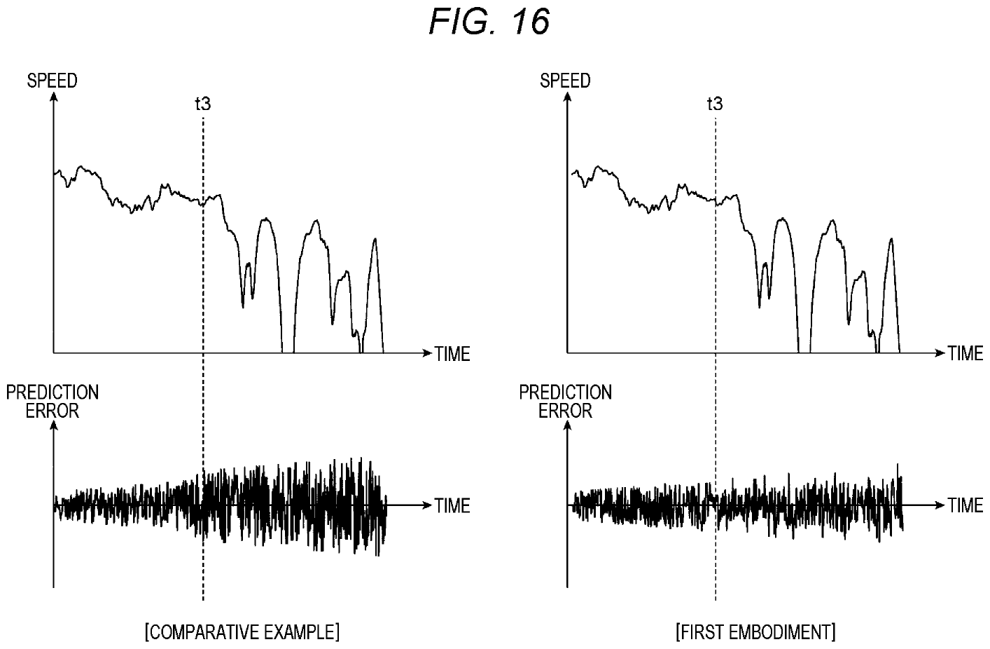

FIG. 16 illustrates a comparison between the acceleration estimation errors in the case (first embodiment) where the statistical database 4 is adjusted in the first embodiment of the present invention and the case (comparative example) where the statistical database 4 is not adjusted. In FIG. 16, similarly to FIG. 15, the upper chart illustrates the speed change of the host vehicle, and the lower chart illustrates the actual measurement value of the acceleration and the error of the acceleration estimation according to the comparative example and the first embodiment.

In the section before the time t3, the constant speed traveling continues, and this causes bias in the statistical database 4. Therefore, in the comparative example, it can be seen that a prediction error increases in a scene where the speed pattern changes after the time t3. Meanwhile, in the first embodiment, the bias of the statistical database 4 is adjusted at the time t3 when the bias occurs in the statistical database 4. As a result, even after the time t3, the acceleration estimation error of the first embodiment is suppressed to be smaller than that of the comparative example.

As described above, in the embodiment of the present invention, the database control unit 6 appropriately performs the deletion processing of the time-series database 3 and the adjustment processing of the statistical database 4, so that the estimation error of the acceleration is reduced, and the likelihood of the driving force based on the reduction is correctly obtained.

<<Effects of First Embodiment>>

As described above, the control unit (vehicle control device) 1 of the first embodiment includes the time-series database 3 that holds the vehicle state including at least the acceleration of the host vehicle in time series, the statistical database 4 that divides the vehicle state into the plurality of classes and holds the number of appearances of the vehicle state belonging to any of the divided classes, and the vehicle state prediction unit 2 that predicts the future vehicle state based on the information regarding the vehicle state held in the time-series database 3 and the statistical database 4 and the vehicle state newly acquired during of the traveling of the host vehicle.

Further, the database control unit 6 that manages data in the time-series database 3 and the statistical database 4 is further included, and the database control unit 6 adjusts the data amount of the time-series database 3 according to position information (traveling position) of the host vehicle and/or adjusts the bias of data in the statistical database 4 according to the number of appearances.

In other words, the control unit (vehicle control device) 1 of the first embodiment includes the time-series database 3 that holds the latest driving characteristic on the basis of the time series, the statistical database 4 that reflects the universal driving characteristic by holding the number of appearances of the combination of the driving characteristics, the database control unit 6 that manages the data in the time-series database 3 and the statistical database 4, and the vehicle state prediction unit 2 that predicts the future vehicle state of the host vehicle on the basis of the vehicle state held in the time-series database 3 and (or) the statistical database 4.

According to the control unit (vehicle control device) 1 of the first embodiment, the estimation of the future acceleration of the host vehicle can be accurately realized, and furthermore, the future driving force of the host vehicle can be accurately predicted. Therefore, in the vehicle control device that controls the engine so as to improve the fuel consumption in consideration of the driving characteristics of the driver and the automatic driving system, the driving characteristics of the driver and the automatic driving system caused by the difference in the traffic environment can be appropriately reflected in the control, and the engine can be controlled so as to improve the fuel consumption in consideration of the driving characteristics of the driver and the automatic driving system regardless of the traffic environment.

### Second Embodiment

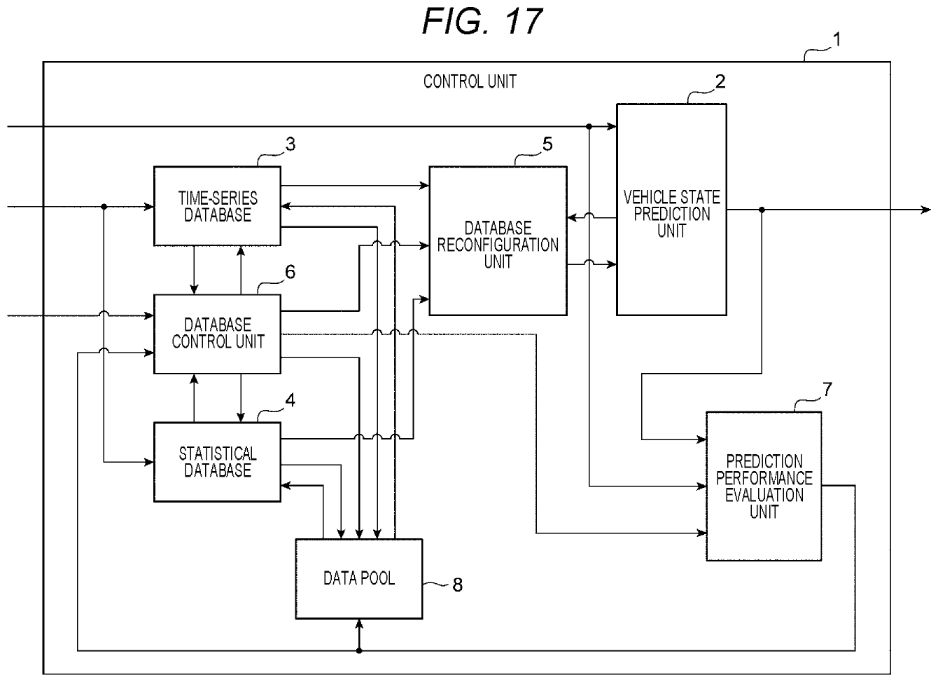

A second embodiment of the present invention will be described with reference to FIG. 17. FIG. 17 is a block diagram illustrating a main part of a vehicle control unit 1 according to the second embodiment. As illustrated in FIG. 17, the second embodiment of the present invention includes a prediction performance evaluation unit 7 and a data pool 8 in a control unit 1. Other configurations are the same as those of the first embodiment, and thus the description thereof will be omitted.

The prediction performance evaluation unit 7 compares the estimation result (acceleration expected value) of the host vehicle acceleration in the vehicle state prediction unit 2 with the acceleration actually generated in the vehicle 100 before and after the deletion of the time-series database 3 and the adjustment of the statistical database 4 are performed by the database control unit 6.

In addition, the data pool 8 copies (copy or save) the data of the time-series database 3 immediately before the deletion of the time-series database 3 and the adjustment of the statistical database 4 are performed, the data of the statistical database 4, or both thereof by the database control unit 6.

The prediction performance evaluation unit 7 repeatedly calculates an error of the acceleration generated in the vehicle 100 corresponding to the time at which the estimation result of the host vehicle acceleration in the vehicle state prediction unit 2 and the estimation result of the host vehicle acceleration are obtained, holds the error for a certain period of time, and calculates an average absolute error in the sections such as 5 seconds, 10 seconds, and 30 seconds.

In the prediction performance evaluation unit 7, the database control unit 6 compares the average absolute errors before and after the deletion of the time-series database 3 and the adjustment of the statistical database 4 are executed, and when the average absolute errors before these operations by the database control unit 6 are small (in other words, in a case where the average absolute error at the time after the execution of these operations by the database control unit 6 is larger than the average absolute error before the execution of these operations by the database control unit 6,), it is determined that these operations by the database control unit 6 are not appropriate, and a data restoration request is sent to the database control unit 6. Upon receiving the data restoration request from the prediction performance evaluation unit 7, the database control unit 6 restores (copied) data deleted from the data pool 8 or before adjustment to the time-series database 3 or the statistical database 4.

In this way, when the deletion of the time-series database 3 or the adjustment of the statistical database 4 by the database control unit 6 is not appropriate, it is possible to suppress deterioration of the prediction accuracy of the acceleration and to maintain high prediction accuracy.

<<Effects of Second Embodiment>>

As described above, the control unit (vehicle control device) 1 of the second embodiment further includes the prediction performance evaluation unit 7 and the data pool 8, and the prediction performance evaluation unit 7 calculates the error between the acceleration of the host vehicle predicted by the vehicle state prediction unit 2 and the acceleration of the host vehicle actually generated, before and after the adjustment of at least one database of the time-series database 3 or the statistical database 4 is performed, the database control unit 6 copies or saves the data of the at least one database in the data pool 8 before the adjustment of the at least one database is performed, and when the error at the time after the adjustment of the at least one database is performed by the database control unit 6 is larger than the error before the adjustment of the at least one database is performed by the database control unit 6, the data of the at least one database copied or saved in the data pool 8 is restored to the at least one database.

According to the control unit (vehicle control device) 1 of the second embodiment, when the deletion of the time-series database 3 by the database control unit 6 or the adjustment of the statistical database 4 is not appropriate, it is possible to suppress deterioration of the prediction accuracy of the acceleration and to maintain high prediction accuracy.

### Third Embodiment

A third embodiment of the present invention will be described. A third embodiment of the present invention relates to the time-series database 3, the statistical database 4, and the database control unit 6. Other configurations are the same as those of the first embodiment, and thus the description thereof will be omitted.

A navigation device 116 (FIG. 1) is mounted on the vehicle 100, and a case where the vehicle 100 travels while using the navigation device 116, such as a case where a driver specifies a destination and route guidance is performed and a case where a travel route including a travel position is accumulated in the navigation device 116, and a case where the driver does not specify a destination and the vehicle 100 travels without performing route guidance are considered.

When a route is set in the navigation device 116 and the set travel route includes a section in which there is no travel track record of the vehicle 100 so far based on the travel position history of the vehicle 100 recorded in the navigation device 116, the database control unit 6 enlarges the memory area of the time-series database 3 and changes the memory location so as to degenerate the memory area of the statistical database 4. In this way, in a section (route) having no travel track record, prediction is performed with emphasis on the data of the time-series database 3 rather than the data of the statistical database 4.

Since the time-series database 3 can reflect the latest travel track record, even a route with poor travel track records can be predicted with relatively high accuracy.

Enlarging the time-series database 3 is equivalent to acting to increase the height of the table of FIG. 9. By enlarging the time-series database 3, even when new data is added, it is possible to lengthen the temporal and spatial distance until deletion beyond the number of storable data. Meanwhile, the method for degenerating the statistical database 4 is realized by reducing the total number of combinations. Therefore, it is possible to degenerate the scale of the statistical database 4 and preferentially allocate the memory region to the time-series database 3 by setting the width of the class of each acceleration determination factor to be relatively wide or narrowing the range of the class such as the upper limit and the lower limit.

<<Effects of Third Embodiment>>

As described above, the control unit (vehicle control device) 1 of the third embodiment further includes the navigation device 116 that sets the route of the host vehicle, and changes the sizes of the time-series database 3 and the statistical database 4 based on the traveling position history of the host vehicle recorded in the navigation device 116. Specifically, in a case where a route having no travel track record is set on the basis of the travel position history of the host vehicle recorded in the navigation device 116, the sizes of the time-series database 3 and the statistical database 4 are changed so as to expand the time-series database 3 and degenerate the statistical database 4.

According to the control unit (vehicle control device) 1 of the third embodiment, even a route with poor travel track records can be predicted with relatively high accuracy.

### Fourth Embodiment

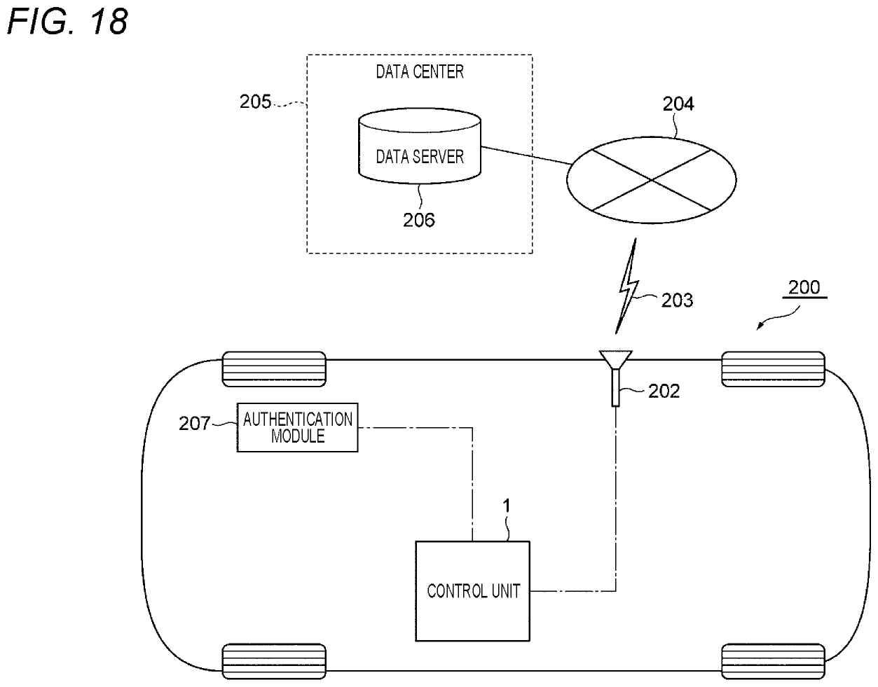

A fourth embodiment of the present invention will be described with reference to FIG. 18. The fourth embodiment of the present invention relates to the time-series database 3 and the statistical database 4. Other configurations are the same as those of the first embodiment, and thus the description thereof will be omitted.

In the first embodiment of the present invention described above, the time-series database 3 or the statistical database 4 has been described with the intention of being constructed on the RAM or the ROM installed in the control unit 1 mounted on the vehicle 100, but the present invention is not limited thereto.

FIG. 18 is a schematic configuration diagram of a vehicle illustrating an example in which the time-series database 3 or the statistical database 4 is provided in a place different from the inside of the control unit 1 mounted on a vehicle 200.

Similarly to the vehicle 100 (FIG. 1), the vehicle 200 having at least the same function as that of the first embodiment of the present invention is mounted with a communication module 202 which is a communication device for performing communication between the vehicle 200 and the outside of the vehicle 200, and the control unit 1 mounted on the vehicle 200 can hold a part or all of data held in the time-series database 3 or the statistical database 4, or data that has not been held in the time-series database 3 or the statistical database 4, in a data server 206 in a data center 205 connected via the wireless communication network 203 and the Internet 204 by the communication module 202.

In this way, it is possible to hold the time series data longer in time and space than the resources of the control unit 1.

Furthermore, since the database control unit 6 saves data to be deleted due to a change in the road type in the data server 206, data suitable for the road type can be quickly reflected to the time-series database 3 without restoring the data from the statistical database 4, and high prediction accuracy can be maintained even when the travel environment changes.

In addition, the vehicle 200 further includes an authentication module 207 which is an authentication device for identifying the driver of the vehicle 200, and holds the driver information identified by the authentication module 207 in association with the data of the time-series database 3, the data of the statistical database 4, or both thereof. In a case where the driver is switched, the individual driver is identified through the authentication module 207, and the data of the time-series database 3 or the data of the statistical database 4 corresponding to the driver (information), or both thereof are read out from the data server 206 in the data center 205 outside the vehicle 200 and restored, whereby the time-series database 3 and the statistical database 4 reflecting the habit and the driving style of the individual driver can be generated even when the vehicle 200 is operated by a plurality of drivers, and the prediction accuracy of the acceleration can be improved.

<<Effects of Fourth Embodiment>>

As described above, the control unit (vehicle control device) 1 of the fourth embodiment further includes the communication module (communication device) 202 that performs communication between the host vehicle and the outside of the host vehicle, and part or all of the data of the time-series database 3 or the statistical database 4, or both thereof is held outside the host vehicle by the communication module (communication device) 202.

Further, the authentication module (authentication device) 207 that identifies the driver of the host vehicle is further provided, and the driver information identified by the authentication module (authentication device) 207 and the time-series database 3, the statistical database 4, or both thereof are held in association with each other, and data of the time-series database 3 or the statistical database 4, or both thereof, corresponding to the driver information is restored from data of a database held outside the host vehicle.

According to the control unit (vehicle control device) 1 of the fourth embodiment, it is possible to hold time-series data longer in time and space than resources of the control unit 1.

In addition, even in a case where the vehicle 200 is operated by a plurality of drivers, it is possible to generate the time-series database 3 and the statistical database 4 reflecting the habit and the driving style of the individual driver, and it is also possible to improve the prediction accuracy of the acceleration.

### Fifth Embodiment

A fifth embodiment of the present invention will be described. In fifth embodiment of the present invention, an oncoming vehicle or a surrounding vehicle which is another vehicle different from the vehicle (host vehicle) 200 is selected as a communication partner via the communication module 202 of the fourth embodiment of the present invention.

The control unit 1 communicates with another vehicle similar to the vehicle 200 via the communication module 202 to exchange the time-series database 3 and the statistical database 4 with a partner vehicle, supply (transmit) the time-series database 3 and the statistical database 4 to the partner vehicle, or receive the time-series database 3 and the statistical database 4 from the partner vehicle. In this way, for example, by exchanging the time-series database 3 with the oncoming vehicle, when it is considered that the oncoming vehicle has experienced an environment similar to the road environment in which the host vehicle is scheduled to travel from now, the state of the route on which the host vehicle is scheduled to travel from now is reflected, and the prediction accuracy can be improved.

In addition, by receiving the supply of the database from the surrounding vehicle or providing the database to the surrounding vehicle, improvement in the prediction accuracy of the acceleration in the travel route having no travel track record for the host vehicle can be expected.

Note that, in such a case, as described in the second embodiment, by saving the data before the exchange of the database in the data pool 8 and comparing the data with the predicted performance before the exchange of the database, it is possible to avoid a decrease in the prediction accuracy of the acceleration when the exchange is not appropriate.

<<Effects of Fifth Embodiment>>

As described above, the control unit (vehicle control device) 1 of the fifth embodiment further includes the communication module (communication device) 202 that performs communication between the host vehicle and the outside of the host vehicle, and the communication module (communication device) 202 exchanges the data of the time-series database 3 or the statistical database 4 or both thereof with another vehicle different from the host vehicle, transmits the data to another vehicle different from the host vehicle, or receives the data from a vehicle different from the host vehicle.

According to the control unit (vehicle control device) 1 of the fifth embodiment, improvement in prediction accuracy of acceleration can be expected.

Examples of the preferred embodiments of the present invention have been described above. In the embodiments of the present invention and the drawings used for the description thereof, only configurations necessary for the description of the invention are described. In a case where the invention is actually implemented, control and functions that are not described in the embodiments of the present invention are naturally achieved using a conventionally known technique. Therefore, the present invention is not necessarily characterized by including all the configurations described above, and is not limited to the configurations of the embodiments described above. It is possible to replace a part of the configuration of a certain embodiment with another embodiment or a conventionally known configuration, and it is possible to add, delete, or replace another configuration with respect to a part of the configuration of each embodiment unless the characteristics thereof are significantly changed.

In addition, the present invention is not limited to the above-described embodiments, and includes various modifications. For example, the above-described embodiments have been described in detail for easy understanding of the present invention, and are not necessarily limited to those having all the described configurations.

In addition, some or all of the above-described configurations, functions, processing units, processing means, and the like may be realized by hardware, for example, by designing with an integrated circuit. In addition, each of the above-described configurations, functions, and the like may be realized by software by a processor interpreting and executing a program for realizing each function. Information such as a program, a table, and a file for realizing each function can be stored in a storage device such as a memory, a hard disk, and a solid state drive (SSD), or a recording medium such as an IC card, an SD card, and a DVD.

In addition, the control lines and the information lines indicate what is considered to be necessary for the description, and do not necessarily indicate all the control lines and the information lines on the product. In practice, it may be considered that almost all the configurations are connected to each other.

### REFERENCE SIGNS LIST

1 vehicle control unit (vehicle control device)
2 vehicle state prediction unit
3 time-series database
4 statistical database
5 database reconfiguration unit
6 database control unit
7 prediction performance evaluation unit
8 data Pool
11 preceding vehicle state prediction unit
12 host vehicle state prediction unit
100, 200 vehicle
101 fuel tank
102 engine
103 generator
104 battery
105 inverter
106 motor
107 traveling device
108 vehicle wheel
109 steering device
110 brake actuator
111 accelerator pedal
112 brake pedal
113 steering angle sensor
114 vehicle speed sensor
115 front recognition sensor
116 navigation device
117 GPS antenna
202 communication module (communication device)
203 wireless communication network
204 Internet
205 data center
206 data server
207 authentication module (authentication device)
1001 host vehicle
1002 preceding vehicle

1. A vehicle control device comprising:
a time-series database that holds a vehicle state including at least an acceleration of a host vehicle in time series;
a statistical database that divides the vehicle state into a plurality of classes and holds the number of appearances of the vehicle state belonging to any of the divided classes; and
a vehicle state prediction unit that predicts a future vehicle state based on information regarding the vehicle state held in the time-series database and the statistical database and on a vehicle state newly acquired during traveling of the host vehicle.

2. The vehicle control device according to claim 1, further comprising a database control unit that manages data in the time-series database and the statistical database,
wherein the database control unit adjusts a data amount of the time-series database according to position information of the host vehicle.

3. The vehicle control device according to claim 2, wherein
the database control unit adjusts the data amount of the time-series database by deleting a part or all of the data held in the time-series database.

4. The vehicle control device according to claim 1, further comprising
a database control unit that manages data in the time-series database and the statistical database, wherein
the database control unit adjusts a bias of data in the statistical database according to the number of appearances.

5. The vehicle control device according to claim 4, wherein
the database control unit adjusts the bias of the data in the statistical database by reducing or adding the number of appearances which causes the bias so as to increase information entropy of the statistical database.

6. The vehicle control device according to claim 5, wherein the database control unit
reduces the number of appearances of a combination in which a ratio of the number of appearances of any selected class combination to the total number of appearances of a class combination held in the statistical database exceeds a predetermined ratio,
or
reduces the number of appearances of the class combination by a number obtained by multiplying an excess over an average by a value less than 1 for the number of appearances exceeding the average, with respect to the number of appearances of the class combination held in the statistical database,
to adjust the bias of data in the statistical database so as to increase the information entropy of the statistical database.

7. The vehicle control device according to claim 2, further comprising
a prediction performance evaluation unit and a data pool, wherein
the prediction performance evaluation unit calculates an error between an acceleration of the host vehicle predicted by the vehicle state prediction unit and an acceleration of the host vehicle actually generated, before and after the adjustment of the time-series database is performed,
the database control unit copies or saves data of the time-series database in the data pool before adjustment of the time-series database is performed, and
when the error at a time after the adjustment of the time-series database is performed by the database control unit is larger than the error before the adjustment of the time-series database is performed by the database control unit,
the data of the time-series database copied or saved in the data pool is restored to the time-series database.

8. The vehicle control device according to claim 4, further comprising a prediction performance evaluation unit and a data pool,
wherein the prediction performance evaluation unit calculates an error between an acceleration of the host vehicle predicted by the vehicle state prediction unit and an acceleration of the host vehicle actually generated, before and after the adjustment of the statistical database is performed,
the database control unit copies or saves data of the statistical database in the data pool before adjustment of the statistical database is performed, and
when the error at a time after the adjustment of the statistical database is performed by the database control unit is larger than the error before the adjustment of the statistical database is performed by the database control unit,
the data of the statistical database copied or saved in the data pool is restored to the statistical database.

9. The vehicle control device according to claim 1, further comprising
a navigation device that sets a route of the host vehicle, wherein
when a route having no travel track record is set based on a travel position history of the host vehicle recorded in the navigation device,
sizes of the time-series database and the statistical database are changed to expand the time-series database and degenerate the statistical database.

10. The vehicle control device according to claim 1, further comprising
a communication device that performs communication between the host vehicle and an outside of the host vehicle, wherein
the time-series database, the statistical database, or a part or all of both the time-series database and the statistical database is held outside the host vehicle by the communication device.

11. The vehicle control device according to claim 10, further comprising
an authentication device that identifies a driver of the host vehicle, wherein
driver information identified by the authentication device is held in association with the time-series database, the statistical database, or both thereof, and
the data of the time-series database, the statistical database, or both thereof corresponding to the driver information is restored from data of a database held outside the host vehicle.

12. The vehicle control device according to claim 1, further comprising
a communication device that performs communication between the host vehicle and an outside of the host vehicle, wherein
the time-series database, the statistical database, or both thereof are exchanged with another vehicle different from the host vehicle, transmitted to another vehicle different from the host vehicle, or received from a vehicle different from the host vehicle, by the communication device.

13. A data adjustment method of at least one of a time-series database that holds a vehicle state including at least an acceleration of a host vehicle in time series and a statistical database that divides a vehicle state into a plurality of classes and holds a number of appearances of a vehicle state belonging to any of the divided classes, the data adjustment method comprising:
adjusting the data of the at least one of the databases in order to improve prediction accuracy of a future vehicle state predicted based on information regarding a vehicle state held in the time-series database and the statistical database and on a vehicle state newly acquired during traveling of the host vehicle.
